(19) United States
(12) Patent Application Publication
(10) Pub. No.: US 2020/0174825 A1
(43) Pub. Date: Jun. 4, 2020

(54) INFORMATION PROCESSING TERMINAL, RESOURCE RESERVATION SYSTEM, AND CONTROL METHOD

(71) Applicant: YASUHIRO HAYASHI, KANAGAWA (JP)

(72) Inventor: YASUHIRO HAYASHI, KANAGAWA (JP)

(73) Assignee: Ricoh Company, Ltd., Tokyo (JP)

(21) Appl. No.: 16/677,897

(22) Filed: Nov. 8, 2019

(30) Foreign Application Priority Data
Nov. 29, 2018 (JP) 2018-224196

(51) Int. Cl. G06F 9/48; G06F 9/54; G06F 9/451; G06F 8/658; G06F 11/32; H04L 29/08

(52) U.S. Cl. CPC G06F 9/4818; G06F 9/542; H04L 67/10; G06F 8/658; G06F 11/323; G06F 9/451

(57) ABSTRACT

An information processing terminal is installed with one or more control target applications. The information processing terminal includes one or more control target applications and one or more processors. The one or more processors are configured to transmit a notification for controlling the one or more control target applications, and execute the one or more control target applications to receive the notification and control operation of the one or more control target applications based on the received notification.

### CROSS-REFERENCE TO RELATED APPLICATION

This patent application is based on and claims priority pursuant to 35 U.S.C. § 119(a) to Japanese Patent Application No. 2018-224196, filed on Nov. 29, 2018, in the Japan Patent Office, the entire disclosure of which is hereby incorporated by reference herein.

### BACKGROUND

### Technical Field

The present disclosure relates to an information processing terminal, a resource reservation system, and a control method.

### Description of Related Art

Application software (hereinafter simply referred to as an “application”) running on an information processing terminal sometimes has some bugs, or functions not yet installed. To address such case, a system is provided that automatically updates an application, whereby a user is saved from upgrading the application to the new version one by himself or herself.

If an application that operates on an information processing terminal can be automatically updated without a user's operation, for example, when there are plural information processing terminals, the work load for updating the application can be reduced. Furthermore, the application can be maintained at the latest version even if an administrator does not visit a place where the information processing terminals are located.

### SUMMARY

According to an embodiment, an information processing terminal is installed with one or more control target applications. The information processing terminal includes one or more control target applications and one or more processors. The one or more processors are configured to transmit a notification for controlling the one or more control target applications, and execute the one or more control target applications to receive the notification and control operation of the one or more control target applications based on the received notification.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an overview of operation performed by a resource reservation system, according to an embodiment of the present disclosure;

FIG. 2 is a schematic diagram for describing an overview of operation performed by a meeting room terminal, according to an embodiment of the present disclosure;

FIG. 3 is a schematic diagram illustrating an example of a system configuration of the resource reservation system, according to an embodiment of the present disclosure;

FIG. 4 is a block diagram illustrating an example of a hardware configuration of a meeting management server, according to an embodiment of the present disclosure;

FIG. 5 is a block diagram illustrating an example of a hardware configuration of the meeting room terminal, according to an embodiment of the present disclosure;

FIGS. 6A and 6B are a block diagram illustrating functional configurations of a reservation management server, a chat server, the meeting management server, and a registration terminal, according to an embodiment of the present disclosure;

FIGS. 7A and 7B are a block diagram illustrating functional configurations of a terminal apparatus and the meeting room terminal, according to an embodiment of the present disclosure;

FIG. 8 is a block diagram illustrating functional configurations of in-terminal communication units, according to an embodiment of the present disclosure;

FIGS. 9A and 9B are diagrams, each illustrating an example of a home screen of the meeting room terminal, according to an embodiment of the present disclosure;

FIG. 10 is a diagram illustrating an example a lifecycle of an application, according to an embodiment of the present disclosure;

FIG. 11 is a sequence diagram illustrating an example of an operation in which a control application acquires a priority level and displays a control target application in the foreground, according to an embodiment of the present disclosure;

FIG. 12 is a diagram illustrating an example of how a screen of the meeting room terminal transitions, according to an embodiment of the present disclosure;

FIG. 13 is a sequence diagram illustrating an example of an operation in which the control application installed in the meeting room terminal registers the meeting room terminal and an application installed in the meeting room terminal in a management apparatus, according to an embodiment of the present disclosure;

FIG. 14 is a sequence diagram illustrating an example of an operation of changing the priority levels held by the control application according to an operation by an administrator or the like and displaying the control target application in the foreground, according to an embodiment of the present disclosure;

FIG. 15 is a diagram illustrating an example of a remote setting screen on which a search result of the meeting room terminal is displayed, according to an embodiment of the present disclosure; and

FIG. 16 is a diagram illustrating an example of the remote setting screen on which a menu for transmitting settings is displayed in response to pressing of Job button, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a description is given of a resource reservation system and a control method performed by the resource reservation system, according to example embodiments of the present disclosure.

Overview of Resource Reservation System:

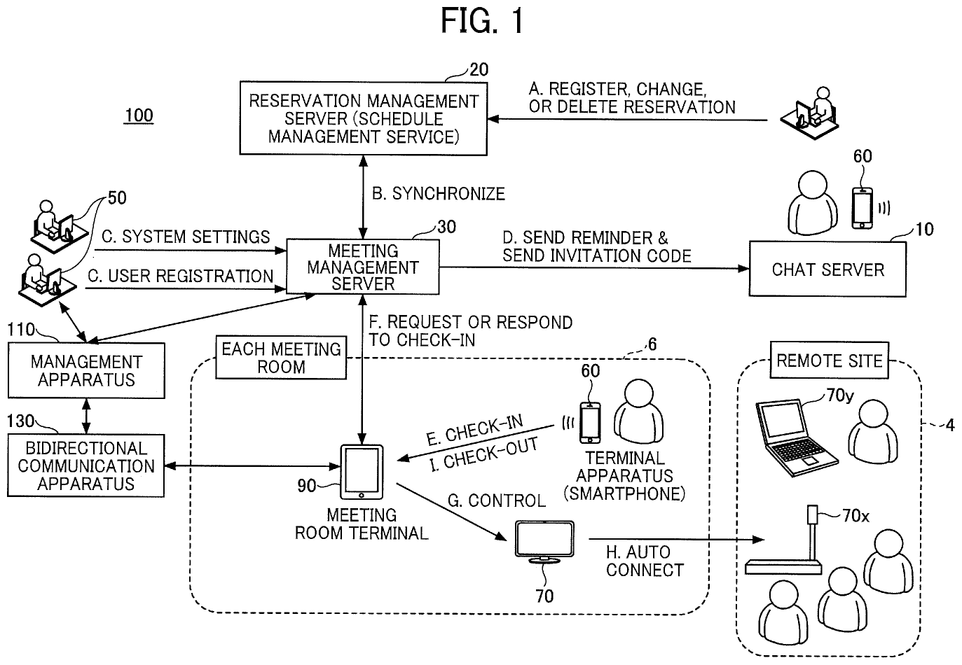

First, a description is given of an overview of a resource reservation system with reference to FIG. 1. FIG. 1 is a diagram illustrating an overview of operation performed by a resource reservation system 100.

A. A user who is to make a reservation operates his or her terminal apparatus 60 to communicate with a reservation management server 20, whereby reserving a meeting room. The reservation management server 20 is implemented by a general-purpose cloud service such as Office365 (registered trademark) or G Suite (registered trademark). In the reservation management server, meeting rooms of an organization such as a company to which the user who made the reservation belongs are registered.

B. A meeting management server 30 is a server that controls entire operation of the resource reservation system 100 based on the reservation status of the meeting room. The meeting management server 30 communicates with the reservation management server 20 at suitable timings to acquire reservation information, so that the reservation information is synchronized between the meeting management server 30 and the reservation management server 20.

C. An administrator or the like of the organization that uses the resource reservation system 100 can perform user registration and configure various settings to the meeting management server 30. The user registration refers to registering an ID for identifying a user using the resource reservation system 100 or an e-mail address of the user in the meeting management server 30. For example, the user registration refers to registering user to whom various notifications are to be sent by a chat server 10 (e.g., Slack (registered trademark), Line (registered trademark), Microsoft Teams (registered trademark)). Further, since the notifications are sent by a bot that transmits a message as the meeting management server 30, the bot provided by the chat server 10 is also registered. The bot is a program for providing a user with an interface via which various notifications are sent or various inputs are received as a proxy of the resource reservation system 100 or the meeting management server 30 on each chat application (a terminal application of a chat system) in a terminal apparatus such as a smartphone of each user. In other words, the bot is a program on the chat server 10. As a virtual chat partner, the bot communicates with a user (a user of the resource reservation system 100) to send notifications, receive inputs, and send various guidance messages, and the like. For example, the bot sends a reminder of reservation information to the user from the resource reservation system 100. Further, for example, the bot receives, as a chat, the user's inputs to the reminder, such as participation or non-participation in a meeting. In other words, the bot serves as the system's contact. Examples of the various settings configured by the administrator or the like to the meeting management server 30 include registration of a meeting room terminal 90 and a setting of a timing when a reminder is to be sent.

D. When the current time is a predetermined time period before the start time of a meeting defined in the reservation information, the meeting management server 30 sends a reminder of the scheduled meeting to the user who made the reservation, thereby reducing an empty reservation of a meeting room. The “empty reservation” refers to reserving resources such as a meeting room that is not actually used. In addition, the meeting management server 30 sends a notification indicating an invitation code (invitation to a group) to the user as needed. In response to receiving the reminder, the user who made the reservation stores information (meeting identification information) for checking in the meeting room in the terminal apparatus 60. The “check-in” or “checking in” refers to a user's input of an instruction for check-in for starting use of the meeting room, and by the meeting management server 30, receiving information indicating the check-in in response to the check-in instruction to perform a process of setting a flag indicating the start of use of the meeting room.

E. The meeting room terminal 90 is located in each of one or more meeting rooms 6. The meeting room terminal 90 downloads, at preset intervals, reservation information for meetings to be held in the meeting room where the meeting room terminal 90 is located. The meeting room terminal 90 displays the schedule of meetings to be held on the current day or the schedule of the most recent meeting, thereby allowing participants of the meeting to confirm the schedule. The user who made the reservation for the meeting room enters the meeting room 6 a little before the start time of the meeting to check in. For example, the user inputs the meeting identification information to the meeting room terminal 90 or the user holds the terminal apparatus 60 over the meeting room terminal 90 (e.g., brings the terminal apparatus 60 near the meeting room terminal 90), thereby causing the meeting room terminal 90 to read the terminal identification information or to perform communication. Further, for example, the user presses a check-in button (use start button) displayed by a terminal application 90a of the meeting room terminal 90.

F. Since the meeting room terminal 90 transmits a check-in request to the meeting management server 30. If the meeting room terminal 90 is authenticated with the meeting identification information, the meeting room terminal 90 receives a response indicating that the check-in has succeeded from the meeting management server 30. The meeting room terminal 90 displays that the meeting room is in use (in session). In a case where the meeting management server 30 does not confirm a use start notification indicating the check-in by a preset time before or after the start time of the meeting, the meeting management server 30 cancels the reservation of the meeting room 6. In other words, the meeting management server 30 cancels the reservation information when the use of the meeting room is not started for a preset time period. Further, the meeting management server 30 transmits, to the meeting room terminal 90, information indicating the reservation is canceled as a status included in the reservation information. In this case, since the meeting room terminal 90 displays information indicating that the meeting room is vacant, any user can use the meeting room 6.

G. The meeting room terminal 90 controls an electronic device 70 in response to a request from the meeting management server 30. For example, the meeting room terminal 90 controls the electronic device 70 so that the power is turned on at the start time of the meeting and turned off at the end time of the meeting, thereby improving convenience when the meeting participant operates the electronic device 70.

H. When the electronic device 70 has, for example, a videoconferencing function, the electronic device 70 can communicate with an electronic device such as a videoconferencing terminal 70x at a remote site 4 to conduct a videoconference (teleconference). Note that a personal computer (PC) 70y on which an application operates can also communicate with the electronic device 70. The reservation information includes destination information (communication ID of a communication destination) indicating the remote site 4 in advance. The electronic device 70 can automatically communicate with the videoconferencing terminal 70x and the PC 70y by using the destination information.

I. When the user who made the reservation ends the meeting, the user presses a button of the meeting room terminal 90 to check out. The meeting room terminal 90 displays the next reservation status, thereby allowing an arbitrary user to check the reservation status of the meeting room.

J. Further a management apparatus 110 and a bidirectional communication apparatus 130 are provided on a network. The management apparatus 110 is communicably connected to the meeting room terminal 90 via the bidirectional communication apparatus 130. The management apparatus 110 is an example of a control apparatus. The bidirectional communication apparatus 130 is a communication apparatus that relays communication from the management apparatus 110 to the meeting room terminal 90 and relays communication from the meeting room terminal 90 to the management apparatus 110. A registration terminal 50 connects to the management apparatus 110 according to an administrator's operation, to receive various settings from the meeting room terminal 90 and transmit various settings to the meeting room terminal 90. Further, the management apparatus 110 is also communicably connected to the meeting management server 30. Accordingly, the management apparatus 110 is also communicable with the meeting room terminal 90 via the meeting management server 30.

Overview of Operation:

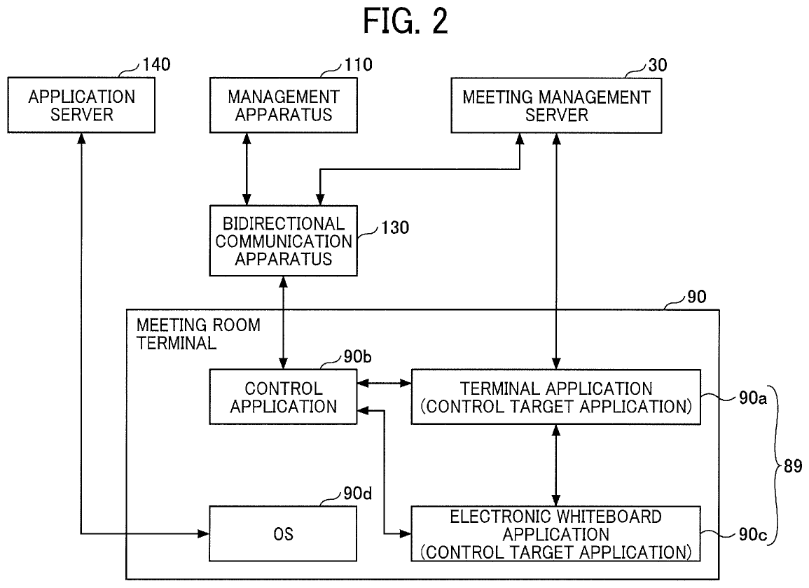

FIG. 2 is a schematic diagram for describing an overview of operation performed by the meeting room terminal 90, according to the present embodiment. In the present embodiment, a control application 90b and control target applications 89 are installed in the meeting room terminal 90. The control application 90b and the control target applications 89 are collectively referred to as an “application” (abbreviation of application software), unless the two application need to be distinguished from each other. The meeting room terminal 90 is provided inside a firewall. The meeting room terminal 90 can receive communication from the management apparatus 110 or the meeting management server 30 via the bidirectional communication apparatus 130. Each application of the meeting room terminal 90 inside the firewall can voluntarily communicate with the meeting management server 30 and the like. An operating system (OS) 90d can voluntarily communicate with an application server 140 on the cloud.

The OS 90d communicates with the application server 140, and when the new versions of the applications installed in the meeting room terminal 90 are present, the OS 90d downloads the new versions of the applications and updates the old versions of the applications to the downloaded new versions. Note that the application needs to be stopped when updated.

The control application 90b is an application that controls operation of the control target applications 89. The control target application 89 has various functions, and is an application having a function of communicating with the control application 90b to receive a notification relating to control. In FIG. 2, the control target application 89 includes a terminal application 90a and an electronic whiteboard application 90c. Since the terminal application 90a is an application that displays a standby screen for receiving a check-in instruction, the terminal application 90a is an application that should be basically displayed in the foreground (the terminal application 90a is an application that should be basically displayed in as a most-top screen on the display).

The control application 90b can communicate with the control target applications 89 to acquire a priority level that is set in advance for each of the control target applications 89. The control application 90b displays one of the control target applications 89 having the highest priority level in the foreground of a display of the meeting room terminal 90. Accordingly, the meeting room terminal 90 can display the standby screen. Even when a different application is activated in the meeting room terminal 90 or when the terminal application 90a to be displayed in the foreground is not displayed, the standby screen can be displayed in the foreground.

In addition, the control target applications 89 need to operate only during the daytime. In other words, the control target applications 89 do not need to operate in the nighttime or holiday. The daytime is an example of a first time zone. The nighttime is an example of a second time zone. For this reason, the control application 90b of the present embodiment controls activation and stop (deactivation) of the control target applications 89. By stopping (deactivating) the control target applications 89, the OS 90d can update the control target applications that are stopped.

The control application 90b can receive settings from the management apparatus 110 via the bidirectional communication apparatus 130. For example, the control application 90b can receive a change of the priority levels of the control target applications 89. In addition, the control application 90b can receive, from the management apparatus 110, settings such as when to stop or start the control target applications 89.

Terms Used in the Disclosure:

The term “resource” refers to a resource such as a meeting room, and equipment, device, person (receptionist), mechanisms, etc. that can be used in the meeting room. From among the resources, a resource that is difficult to move is referred to as a “facility”. In the present embodiment, for the sake of explanatory convenience, the term “meeting room” is used as an example of the resource.

The term “control target application” refers to an application that receives a control instruction from a control application and controls the control target application itself according to the received control instruction. The control target application can be also controlled by the control application via the function of the OS. The control target application can have any functions.

The term “control application” refers to an application that controls operation of the control target application. The control application itself can display a standby screen or have any function such as receiving an input of handwritten information.

The control of the control target application includes any actions that change the state or operation of the control target application from extraneous sources. The term “control” can be referred to as “notify”, “communicate”, “transmit”, “change” or the like.

Example of System Configuration:

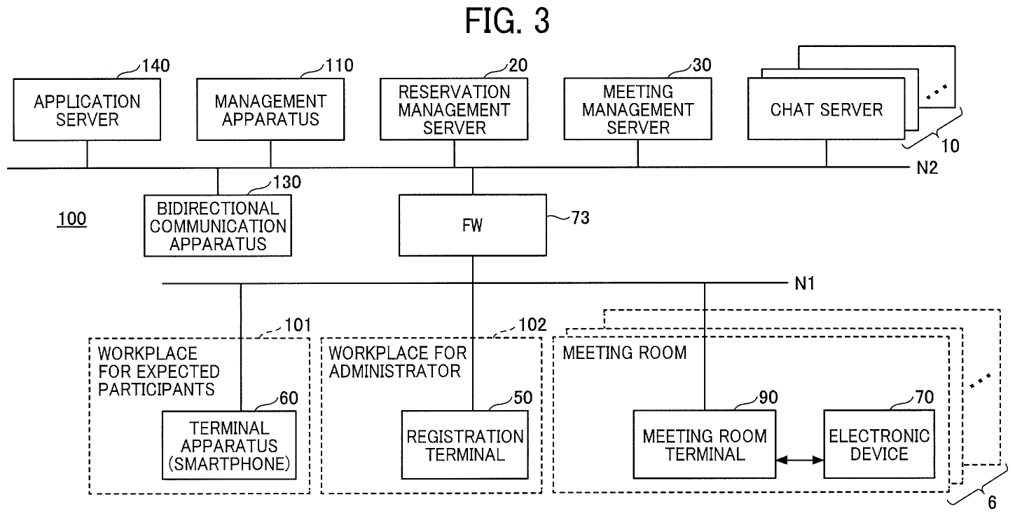

FIG. 3 is a schematic view illustrating an example of a system configuration of the resource reservation system 100. The resource reservation system 100 is mainly divided into an external network N2 and an intra-company network N1. The intra-company network N1 refers to a network (on-premises) inside a firewall 73. The external network N2 is a network such as the Internet, through which an unspecified number of communications are transmitted.

The reservation management server 20, the meeting management server 30, one or more chat servers 10, and the bidirectional communication apparatus 130 that communicates with the management apparatus 110 are communicably connected to the external network N2. Further, the terminal apparatus 60 operated by a participant attending a meeting can be connected to the external network N2 as needed.

The reservation management server 20 is implemented by one or more information processing apparatuses (computer system), each including a general-purpose server operating system (OS) or the like. A system relating to the reservation for a resource, which system is provided by the reservation management server 20, is referred to as a reservation management system. The reservation management server 20 has a calendar system and provides a web application for managing various schedules. Specifically, the web application provides the following functions, for example:

To receive schedule registration, and enable a user who made a reservation to confirm the reservation arbitrarily;

To send a reminder email at the preset date and time, such as 30 minutes before the schedule time;

To enable one person to manage schedules using plural calendars (for business, for private, etc.); and

To share a calendar with users belonging to the same group.

The reservation management server 20 manages a user using an account. The account refers to a right for a user to use a service. In many systems, the user logs in to a system using the account. For this reason, the account has a function (function of identification information) to enable the system to uniquely identify the user. In the present embodiment, the reservation management server 20 transmits reservation information of the account (domain) registered in advance to the meeting management server 30. Alternatively, the meeting management server 30 requests the reservation information by specifying the account of the reservation management server 20, thereby acquiring the reservation information of the meeting room 6 from the reservation management server 20. The account can be any suitable information based on which a user can be uniquely identified. Examples of the account include an e-mail address, an ID, and a telephone number.

Although in the present embodiment, the reservation management server 20 manages the reservation of each meeting room 6 as a schedule, the reservation management server 20 is configured to manage various types of schedules in addition to the reservation of each meeting room 6. The reservation management server 20 can be used for reservations for various types of resources other than each meeting room 6, such as a reservation for rental of various electronic devices, a reservation for a parking lot, a rental office, a rental studio, a rental bicycle, a rental car, accommodation facilities such as hotels, a rental space such as event venues and lockers.

Although G Suite (registered trademark), Office 365 (registered trademark), and the like are known as the reservation management server 20 or the reservation management system including the reservation management server, any other suitable reservation management system having functions described in the present embodiment will suffice.

Further, in the present embodiment, information relating to the one or more meeting rooms 6 within the intra-company network N1 is registered in advance in the reservation management server 20. In other words, the web application of the reservation management server 20 is customized according to a meeting room name, a meeting room ID, a reservation available time, a capacity, a unit of reservation and the like of each meeting room 6 residing within the intra-company network N1 of a company using the resource reservation system 100. Accordingly, each meeting room 6 of the company using the resource reservation system 100 is associated with the reservation information.

The chat server 10 is implemented by one or more information processing apparatuses (computer system), each including a general-purpose server OS or the like. A system for real-time sharing of information, such as text, audio and video by a plurality of users provided by the chat server 10 is referred to as a chat system. The chat server 10 notifies the terminal apparatus 60 of the information about the reservation of the meeting room 6. In the present embodiment, the resource reservation system 100 can include a plurality of chat servers 10 operated by different entities respectively.

The information shared in the chat system includes image data, audio data, etc., in addition to text. In the present embodiment, a description is given of an example case in which text is mainly used for the notification, for the sake of explanatory convenience. For example, the chat system can provide a voice chat capability for the group. The voice chat can be a one-to-one voice chat or a one-to-N voice chat, where N≥2. In other words, according to the present embodiment, the chat system notifies the information about the reservation of the meeting room 6 by outputting a voice message, in addition to or in alterative to, displaying text. LINE (registered trademark), Slack (registered trademark), Microsoft Teams (registered trademark) and the like are known as chat systems, but any chat system having a capability of transmitting notification to one or a plurality of users from a bot (a program that executes predetermined processes) will suffice.

The chat server 10 also manages a user by using an account, which is different from the account of the reservation management server 20. The meeting management server 30 basically does not need to recognize the account of the chat server 10. However, the meeting management server 30 can transmit a notification by specifying a desired account of the chat server 10.

The meeting management server 30 is implemented by one or more information processing apparatuses (computer system), each including a general-purpose server OS or the like. As a process relating to the external network N2, the meeting management server 30 acquires the reservation information of the meeting room 6 from the reservation management server 20. Further, the meeting management server 30 acquires an expected participant set in the reservation information and transmits a notification to the group of the chat server 10 (or to an individual user such as a user who made the reservation) associated with the acquired expected participant at a preset time. As a process related to the intra-company network N1, the meeting management server 30 manages a check-in and a check-out to and from the meeting room 6. Further, the meeting management server 30 controls turning on or off of the electronic device 70, based on the reservation information of the meeting room 6 acquired from the reservation management server 20.

The management apparatus 110 is an information processing apparatus that provides the registration terminal 50 with a web application that receives various settings for the meeting room terminal 90 from the administrator. In other words, the management apparatus 110 functions as a so-called web server that generates screen information for accepting various settings for the meeting room terminal 90 and transmits the generated screen information to the registration terminal 50.

The bidirectional communication apparatus 130 is an information processing apparatus that provides a bidirectional communication service between an information processing apparatus on the cloud and an information processing apparatus (on-premises information processing apparatus) inside the firewall. The bidirectional communication apparatus 130 allows the management apparatus 110 or the meeting management server 30 to communicate with the meeting room terminal 90, which resides inside the firewall. For example, Azure IoT Hub (registered trademark) is known as the bidirectional communication apparatus 130 130. However, any other suitable apparatus can be used as the bidirectional communication apparatus 130.

There are the meeting room 6, a workplace 101 for an expected participant, a workplace 102 for an administrator, and the like in the intra-company network N1. An expected participant can access the external network N2 via the intra-company network N1 from various locations. Examples of the intra-company network N1 include a local area network (LAN). The meeting room 6, the workplace 101 for an expected participant, and the workplace 102 for an administrator are not necessarily in a LAN of the same company.

In the meeting room 6, the meeting room terminal 90 and the electronic device 70 are located. The meeting room terminal 90 and the electronic device 70 can communicate with each other via a small-scale LAN or a dedicated line. The electronic device 70 can connect to the intra-company network N1 and the external network N2 without intervening the meeting room terminal 90. The meeting room terminal 90 and the electronic device 70 can communicate with each other either wirelessly or by wire. Since the intra-company network N1 is inside the firewall 73, it is difficult to perform direct communication from the external network N2 to the intra-company network N1.

The meeting room terminal 90 is an information processing terminal operated by a meeting participant who uses the meeting room 6, such as the user who made the reservation for the meeting. For example, the meeting room terminal 90 is provided on a desk in the meeting room 6 or at an entrance of the meeting room 6. A plurality of the meeting room terminals 90 can be provided in one meeting room 6. The meeting room terminal 90 is implemented by one or more information processing apparatuses (computer system), each including a general-purpose OS or the like.

For example, the meeting room terminal 90 transmits the meeting room ID to the meeting management server 30, to display the reservation information of the meeting room 6 of the current day. In addition, the meeting room terminal 90 periodically sends a request for reservation information to the meeting management server 30, to acquire reservation information that is changed. Furthermore, the meeting room terminal 90 acquires control information such as turning on or off of the electronic device 70 from the meeting management server 30. The meeting room terminal 90 turns on or off the electronic device 70 using the acquired control information.

The meeting room terminal 90 displays a standby screen for receiving an instruction for check-in, check-out, etc. Further, the meeting room terminal 90 communicates with the meeting management server 30, to notify the meeting management server 30 of the check-in or the check-out. In response to receiving the instruction for check-in, the meeting room terminal 90 transmits, to the meeting management server 30, meeting identification information that is input by the user who made the reservation and a meeting room ID that the meeting room terminal 90 holds in advance. Base on the meeting identification information and the meeting room ID transmitted from the meeting room terminal 90, the meeting management server 30 can confirm that the user who made the reservation for the meeting room 6 uses the reserved meeting room 6.

The electronic device 70 is office equipment of various types that can be used in the meeting room 6. Examples of the electronic device 70 include an electronic whiteboard, a multifunction peripheral, a projector, a digital signage, and a digital camera. The electronic whiteboard includes a large-sized display that supports a touch panel system. The electronic whiteboard detects coordinates of positions on a screen touched by such as a user's finger or a stylus, and connects the detected coordinates to display a stroke. In addition, the electronic whiteboard is configured to display an image in accordance with data output from a PC that is connected to the electronic whiteboard. Further, the electronic whiteboard is configured to communicate with other electronic whiteboard located in a remote site to share the displayed stroke in a synchronous manner. The electronic whiteboard can be referred to as an electronic information board, etc.

The multifunction peripheral has multiple functions, such as a copier function, a scanner function, a printer function, and/or a facsimile transmitting/receiving function. The multifunction peripheral is used for printing or copying documents, scanning documents for conversion to digital data, and faxing documents during the meeting. The projector is a device that projects an image. For example, the projector projects an image (still image or moving image) displayed on a display of the terminal apparatus 60 onto a screen, etc., to enable the participants to share the image. The digital signage is a large-sized display, and is used for displaying any arbitrary still images or moving images. The digital camera is used by each participant to capture an image formed on paper documents or presentation materials displayed on the electronic whiteboard for storage.

The terminal apparatus 60 that is configured to connect to the intra-company network N1 is provided in the workplace 101 for an expected participant. The terminal apparatus 60 can perform communication by wire or wirelessly. The terminal apparatus 60 is an information processing apparatus used when an expected participant (including a user who makes a reservation) reserves a meeting room. The expected participant (including the user who makes a reservation) can also use the terminal apparatus 60 in the meeting room. In other words, the terminal apparatus is an information processing apparatus carried by the expected participant.

The terminal apparatus 60 is implemented by one or more information processing apparatuses (computer system), each including a general-purpose OS or the like. Examples of the terminal apparatus 60 include a smartphone, a tablet terminal, a PC, a personal digital assistant (PDA), a wearable PC such as smart glasses and a smartwatch. Further, the terminal apparatus 60 can be any suitable device, terminal or apparatus, provided that the device, terminal or apparatus has a communication capability and browser software or application software dedicated to the chat server 10 or the reservation management server 20 that operates on the device, terminal or apparatus. For example, the terminal apparatus 60 can be a car navigation system, a game machine, a television receiver, and the like.

In the terminal apparatus 60, application software dedicated to the chat server 10 and application software dedicated to the resource reservation system 100 operate. The application software dedicated to the chat server 10 is referred to as a “chat application” hereinafter. The application software dedicated to the resource reservation system 100 is referred to as a “meeting application” hereinafter. Browser software can be substituted for either one or both of the chat application and the meeting application.

The registration terminal 50 that is configured to connect to the intra-company network N1 is provided in the workplace 102 for an administrator. The registration terminal 50 can perform communication by wire or wirelessly. The registration terminal 50 is a terminal, by using which an administrator configures various settings to the meeting management server 30.

The registration terminal 50 is implemented by the similar or substantially the similar information processing apparatus(es) that is constituted as the terminal apparatus 60. However, since the registration terminal 50 is used mainly by an administrator for configuring settings to the meeting management server 30, the chat application and the meeting application can be omitted from the registration terminal 50. The registration terminal 50 communicates with the meeting management server 30 mainly by browser software, and displays a web page.

Hardware Configuration:

Hardware Configuration of Meeting Management Server:

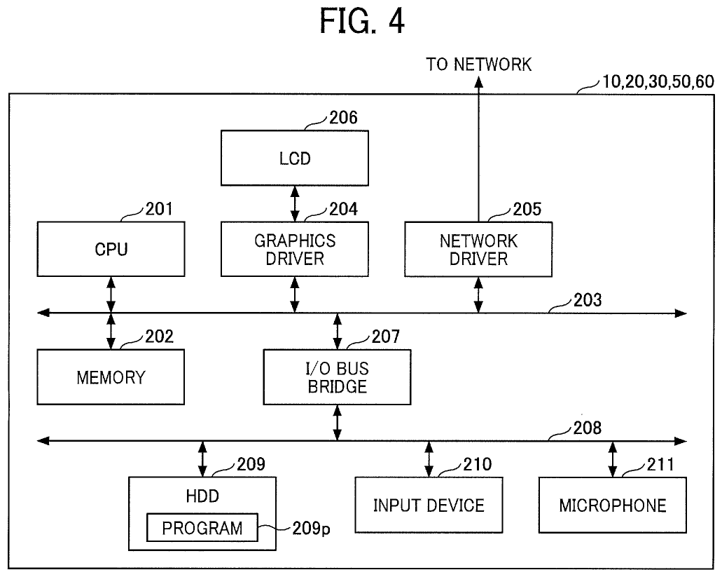

FIG. 4 is a block diagram illustrating an example of a hardware configuration of the meeting management server 30. The meeting management server 30 includes a central processing unit (CPU) 201 and a memory 202 that enables high-speed access to data by the CPU 201. The CPU 201 and the memory 202 are connected to other devices or drivers of the meeting management server 30, such as a graphics driver 204 and a network driver (NIC) 205, via a system bus 203.

The graphics driver 204 is connected to a liquid crystal display (LCD) 206 via a bus. The graphics driver 204 monitors a processing result by the CPU 201. The LCD 206 is an example of a display device/display. Further, the network driver 205 connects the meeting management server 30 to the external network N2 at a transport layer level and a physical layer level to establish a session with other devices or apparatuses.

An input/output (I/O) bus bridge 207 is further connected to the system bus 203. On the downstream side of the I/O bus bridge 207, a storage device such as a hard disc drive (HDD) 209 is connected via an I/O bus 208 such as a peripheral component interconnect (PCI), in compliance with the Integrated Drive Electronics (IDE), Advanced Technology Attachment (ATA), AT Attachment Packet Interface (ATAPI) 801, serial ATA, Small Computer System Interface (SCSI), Universal Serial Bus (USB), etc. The HDD 209 stores a program 209p for controlling an overall operation of the meeting management server 30. A solid state drive (SSD) can be used in alternative to the HDD 209. The program 209p can be distributed on a storage medium. Alternatively, the program 209p can be distributed from a server for program distribution.

An input device 210, such as a keyboard and a mouse (called a pointing device), as well as a microphone 211, are connected to the I/O bus 208 via a bus such as a USB. The input device 210 and the microphone 211 accepts inputs or instructions by an operator such as a system administrator.

It should be noted that the illustrated hardware configuration of the meeting management server 30 indicates hardware elements preferably included in the meeting management server 30.

Each of the reservation management server 20, the chat server 10, the registration terminal 50, and the terminal apparatus 60 has the same or substantially the same hardware configuration as that of the meeting management server 30 illustrated in FIG. 4. Any of those servers, terminal, or devices can have a different hardware configuration as long as such differences cause no problem in describing the resource reservation system 100 of the present embodiment. In addition, the hardware configurations of the meeting management server 30, the reservation management server 20, and the chat server 10 of the present embodiment do not have to be static, since they support cloud computing. In other words, any of those servers can be configured as hardware resources that are dynamically connected/disconnected according to load. The “cloud computing” refers to internet-based computing where resources on a network are used or accessed without identifying specific hardware resources.

Meeting Room Terminal:

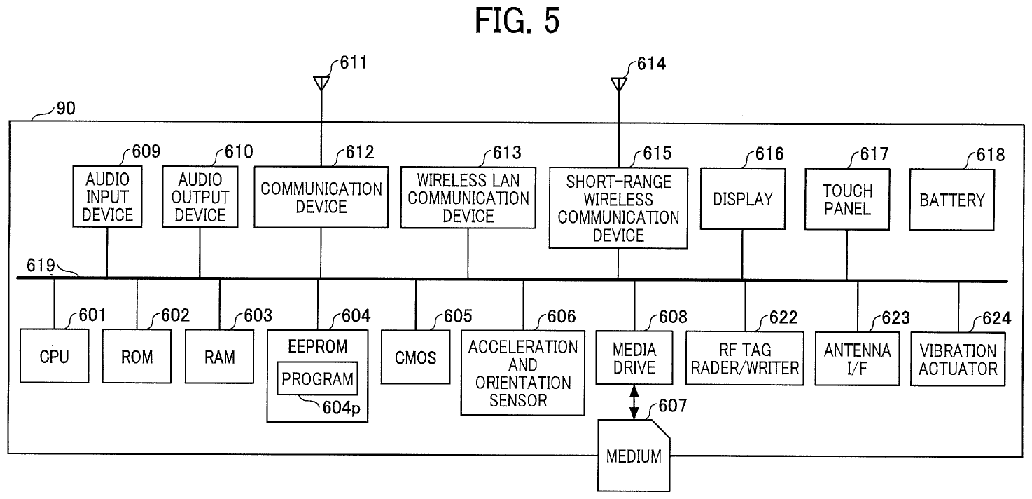

FIG. 5 is a block diagram illustrating an example of a hardware configuration of the meeting room terminal 90. FIG. 5 illustrates a hardware configuration of a tablet apparatus, as an example of the meeting room terminal 90. The meeting room terminal 90 includes a CPU 601, a read only memory (ROM) 602, a random access memory (RAM) 603, an electrically erasable and programmable ROM (EEPROM) 604, a complementary metal oxide semiconductor (CMOS) sensor 605, an acceleration and orientation sensor 606, and a media drive 608.

The CPU 601 controls entire operation of the meeting room terminal 90. The ROM 602 stores a basic input/output program. The RAM 603 is used as a work area for the CPU 601. The EEPROM 604 reads or writes data under control of the CPU 601. The CMOS sensor 605 captures an object under control of the CPU 601 to obtain image data. Examples of the acceleration and orientation sensor 606 includes an electromagnetic compass or gyrocompass for detecting geomagnetism, and an acceleration sensor.

The media drive 608 controls reading and writing (storing) of data from and to a medium 607 such as a flash memory. The medium 607 is removably mounted to the media drive 608. Accordingly, under control of the media drive 608, data recorded in the medium 607 is read from the medium 607 and new data is written (stored) into the medium 607.

The EEPROM 604 stores a program 604p executed by the CPU 601. The program 604p is application software or an OS for executing various processes of the embodiment. The program 604p can be distributed on the medium 607. Alternatively, the program 604p can be distributed from a server for program distribution.

The CMOS sensor 605 is a charge-coupled device that converts an image of an object into electronic data through photoelectric conversion. As an alternative to the CMOS sensor 605, a charge-coupled device (CCD) can be used, provided that it is configured to capture an object. The CMOS sensor 605 is configured to read bar codes and two-dimensional barcodes.

Furthermore, the meeting room terminal 90 includes a radio-frequency (RF) tag reader/writer 622, an antenna interface (I/F) 623, and a vibration actuator 624. The RF tag reader/writer 622 performs communication in compliance a standard such as near-field communication (NFC).

The vibration actuator 624 is a motor configured to vibrate the meeting room terminal 90. For example, the vibration actuator 624 causes the meeting room terminal 90 to vibrate, to notify the participants that the end time of a meeting is approaching.

The meeting room terminal 90 further includes an audio input device 609, an audio output device 610, an antenna 611, a communication device 612, a wireless LAN communication device 613, an antenna 614 for a short-range wireless communication network, a short-range wireless communication device 615, a display 616, a touch panel 617, and a bus line 619.

The audio input device 609 converts sound into an audio signal. The audio output device 610 converts an audio signal into sound. The communication device 612 communicates with a nearest base station apparatus by using radio communication signals using the antenna 611. The wireless LAN communication device 613 performs wireless LAN communication conforming to the IEEE 802.11 standard, for example.

The short-range wireless communication device 615 is a communication device conforming to communication standards such as Bluetooth (registered trademark) or Bluetooth Low Energy (registered trademark). The short-range wireless communication device 615 performs communication using the antenna 614 for a short-range wireless communication network.

The display 616 displays an image of an object, various kinds of icons, etc. Examples of the display 616 include an LCD or an organic electroluminescence display. The touch panel 617 is disposed on the display 616. Examples of the touch panel 617 include a pressure-sensing panel and an electrostatic panel. The touch panel 617 detects a position on the display 616 touched by a finger, a stylus, etc. The bus line 619 is an address bus or a data bus, which electrically connects these hardware elements of the meeting room terminal 90.

The meeting room terminal 90 further includes a battery 618 dedicated to the meeting room terminal 90. The meeting room terminal 90 can be driven by either the battery 618 or a commercial power supply. The audio input device 609 includes a microphone to collect sound. The audio output device 610 includes a speaker to output sound.

Functions:

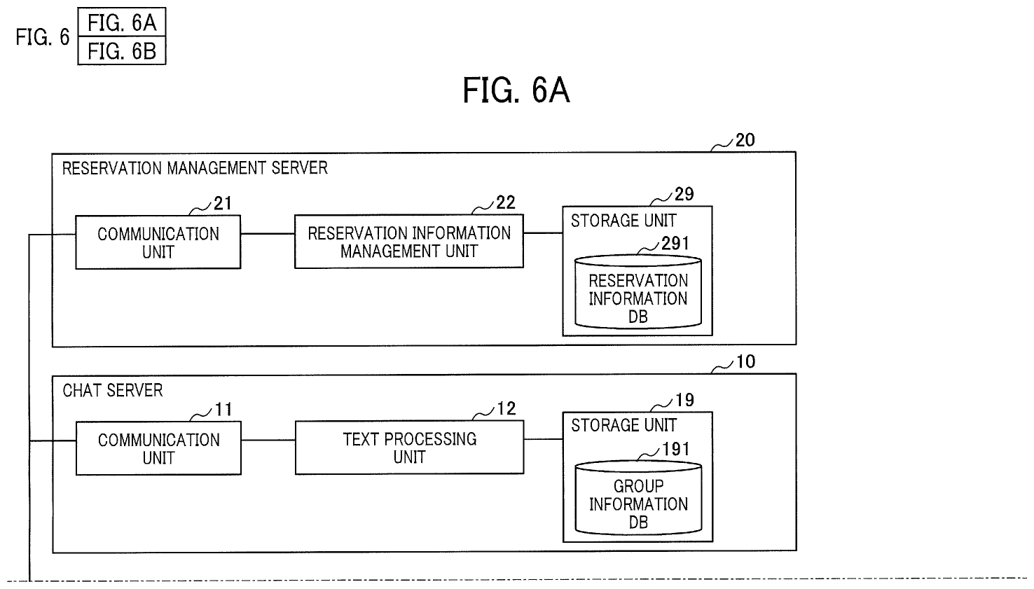

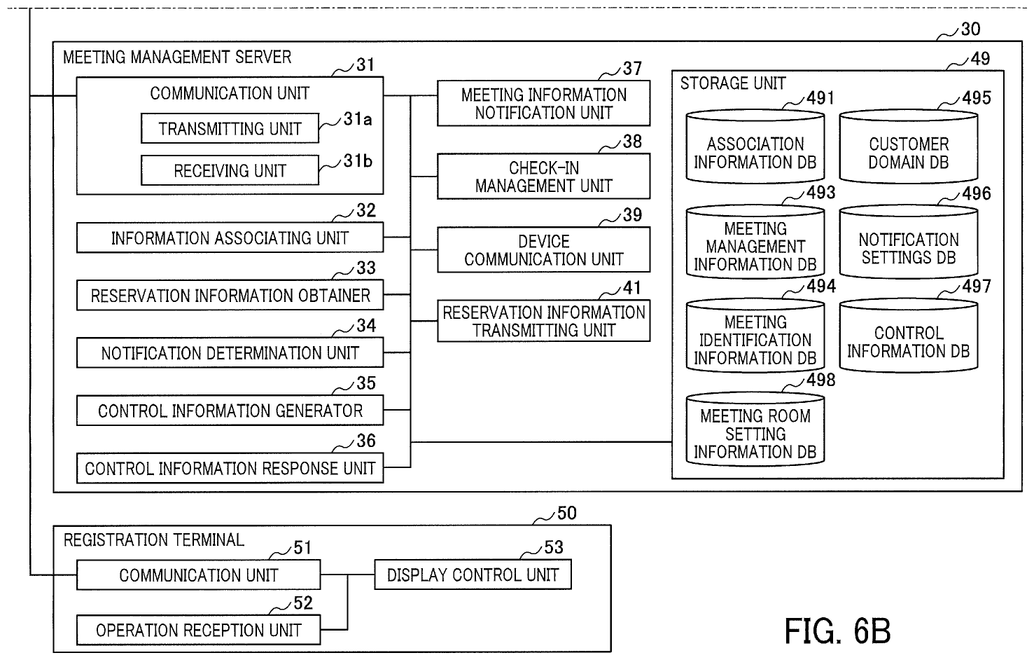

FIGS. 6A and 6B are a block diagram illustrating the functional configurations of the reservation management server 20, the chat server 10, the meeting management server 30, and the registration terminal 50.

Reservation Management Server:

The reservation management server 20 includes a communication unit 21 and a reservation information management unit 22. These functional units of the reservation management server 20 are functions or means that are implemented by operating one or more hardware components illustrated in FIG. 4 in cooperation with instructions of the CPU 201 according to the program 209p loaded from the HDD 209 to the memory 202.

The communication unit 21 transmits and receives various types of information to and from the meeting management server 30 and the terminal apparatus 60. The communication unit 21 transmits screen information of a reservation setting screen to the terminal apparatus 60 and receives a reservation setting from the terminal apparatus 60. Further, the communication unit 21 transmits reservation information to the meeting management server 30.

The reservation information management unit 22 is a general-purpose web server (web application) that receives reservation information. Further, the reservation information management unit 22 manages reservation information registered by a user. When reservation information is registered (or changed), the reservation information management unit 22 notifies the meeting management server 30 of an account of the user who made the reservation. Further, the reservation information management unit 22 transmits reservation information to the meeting management server 30 via the communication unit 21, in response to a request specifying an account from the meeting management server 30. The reservation information management unit 22 may transmit, to the meeting management server 30, reservation information to which any change was made, even if there is no request from the meeting management server 30. A general-purpose web application can be used to enable a user who is to make a reservation to register a reservation for the meeting room 6 in the reservation management server 20.

The reservation management server 20 further includes a storage unit 29. The storage unit 29 is implemented by, for example, the memory 202 and the HDD 209 of FIG. 4. The storage unit 29 stores reservation information database (DB) 291.

TABLE 1
Reservation information DB

| | Account of | | | | | Accounts of |
|---|---|---|---|---|---|---|
| Reservation | reservation- | Meeting | Meeting | Start | End | expected |
| ID | making user | name | ID | time | time | participants |
| 001 | a@xfood.com | Product Z | K-001 | 2017 Jul. 7 | 2017 Jul. 7 | b@xfood.com |
| | | development | | 10:00 | 12:00 | c@xfood.com |
| | | meeting | | | | d@xfood.com |
| 002 | e@xfood.com | Product Y | K-001 | 2017 Jul. 7 | 2017 Jul. 7 | f@xfood.com |
| | | development | | 13:00 | 14:00 | g@xfood.com |
| | | meeting | | | | |
| . . . | . . . | . . . | . . . | . . . | . . . | . . . |

Table 1 illustrates an example data structure of reservation information stored in the reservation information DB 291. The reservation information is information for managing a reservation state of the meeting room 6. The reservation information includes, for each of reservation IDs, an account of a reservation-making user, a meeting name, a meeting room ID, a start time of the meeting, an end time of the meeting, and accounts of expected participants in association with the reservation ID. The reservation ID is identification information for identifying one record of the reservation information. ID is an abbreviation for “identification,” and means an identifier or identification information. ID is any one of a name, a symbol, a character string, a numerical value, or a combination of at least two of these items, which is used to uniquely identifying a specific object from among a plurality of objects. The same applies to other IDs than the reservation ID. The account of the reservation-making user is an account of an expected participant who made a reservation for the meeting room 6. The meeting name is a name of a meeting, which is given by the expected participant at his or her choice. The meeting room ID is identification information for identifying the meeting room 6 that resides on the intra-company network N1. The start time is the beginning of a time slot during which the meeting room 6 is reserved. In other words, the start time is a time when the meeting is to be started. The end time is the end of the time slot during which the meeting room 6 is reserved. In other words, the end time is a time when the meeting is to be ended. The accounts of expected participants are accounts of expected participants who are scheduled to attend the meeting. Each of the accounts in Table 1 is issued by the reservation management server 20.

Chat Server:

The chat server 10 includes a communication unit 11 and a text processing unit 12. These functional units of the chat server 10 are functions or means that are implemented by operating one or more hardware components illustrated in FIG. 4 in cooperation with instructions of the CPU 201 according to the program 209p loaded from the HDD 209 to the memory 202.

The communication unit 11 transmits and receives various types of information to and from the meeting management server 30. In the present embodiment, the communication unit 11 receives, from the meeting management server 30, information about reservation of a meeting room, information for identifying the bot, and information for specifying a group as a destination to which a notification is to be sent. Examples of the information for identifying the bot include a token. This information for identifying the bot is notified in advance as identification information of the bot from the chat server 10, when generating the bot of the meeting management server 30. Further, the communication unit 11 may receive information specifying an account of an individual such as a user who made the reservation. Furthermore, the communication unit 11 transmits, to the meeting management server 30, information indicating that an expected participant has read the information about the reservation of the meeting room or a response made by an expected participant to the displayed information about the reservation of the meeting room.

The text processing unit 12 identifies a group to which a notification is to be sent based on the information transmitted from the meeting management server 30, i.e., the information identifying the bot and the information specifying the group as a destination to which the notification is to be sent. The text processing unit 12 transmits, to the expected participants belonging to the identified group, information about the reservation of the meeting room 6 as information that the bot sends. In one example, the number of notifications transmitted by the text processing unit 12 is equal to the number of the expected participants. In another example, the notification is transmitted only to the user who made the reservation or only to user(s) registered as a notification destination.

The text processing unit 12 is configured to send a so-called “push notification”. A known system provided by each OS is used for the push notification.

The chat server 10 further includes a storage unit 19. The storage unit 19 is implemented by, for example, the memory 202 and the HDD 209 of FIG. 4. The storage unit 19 stores group information DB 191.

TABLE 2
Group Information DB

| | | Member | Member | Member | Member | |
|---|---|---|---|---|---|---|
| Workspace | Channel | Account 1 | Account 2 | Account 3 | Account 4 | Bot account |
| http://sample.com/1 | #marketing | a@chat.com | b@chat.com | c@chat.com | d@chat.com | robo@chat.com |
| http://sample.com/2 | #team1 | b@chat.com | d@chat.com | | | |
| http://sample.com/3 | #ip | f@chat.com | g@chat.com | h@chat.com | | robo@chat.com |
| . . . | . . . | . . . | . . . | . . . | . . . | . . . |

Table 2 illustrates an example data structure of group information stored in the group information DB 191. The group information is information in which accounts of members belonging to the same group are registered. In the group information, member accounts 1 to n (n=4 in Table 2) and a bot account are registered in association with a work place and a channel.

A workspace is identification information for identifying an organization such as a company or a department. In the present embodiment, a plurality of members belong to a workspace (for example, Company A). Examples of the workspace include a uniform resource locator (URL). Alternatively, any suitable information other than the URL is used as the workspace, provided that the information is unique. Further, the workspace has a plurality of channels according to the purpose of chatting. A channel is a group of members among whom information is shared, such as a group for Product A and a group for Product B. One or more members belonging to the workspace belong to the channel. In other words, the notification destination is specified by the workspace and the channel. However, the notification destination is identified in different ways depending on what chat system is used for notification. Accordingly, if there is any identification information based on which a group is uniquely identified, such information can be used to identify the notification destination. In another example, three or more items of information can be used for identifying the notification destination.

The channels are uniquely identified from one another. The member accounts 1 to n are accounts of members belonging to the channel. Each of these accounts is issued by the chat server 10. In the present embodiment, the bot is registered as a member for notifying other members belonging to the same group of information about the reservation of the meeting room 6. In other words, the bot is a kind of a proxy of the meeting management server 30 or a fictitious member. A comment (text) by the bot is transmitted to the terminal apparatus 60 of each of the member accounts 1 to n.

The workspace and channel are managed by the meeting management server 30. The workspace and channel are information for identifying the group to which the participant belongs.

Meeting Management Server:

The meeting management server 30 includes a communication unit 31, an information associating unit 32, a reservation information obtainer 33, a notification determination unit 34, a control information generator 35, a control information response unit 36, a meeting information notification unit 37, a check-in management unit 38, a device communication unit 39, and a reservation information transmitting unit 41. These functional units of the meeting management server 30 are functions or means that are implemented by operating one or more hardware components illustrated in FIG. 4 in cooperation with instructions of the CPU 201 according to the program 209p loaded from the HDD 209 to the memory 202. The program 209p can be distributed from a server for program distribution. Alternatively, the program 209p can be distributed on a storage medium.

The communication unit 31 transmits and receives various kinds of information to and from the reservation management server 20, the chat server 10, the registration terminal 50, and the terminal apparatus 60. The communication unit 31 includes a transmitting unit 31a and a receiving unit 31b. The receiving unit 31b receives reservation information from the reservation management server 20 and receives a request for reservation information from the meeting room terminal 90. Further, the receiving unit 31b receives a check-in request from the meeting room terminal 90. Furthermore, the receiving unit 31b receives, from the registration terminal 50 operated by the administrator, information indicating an association between the group of the chat system and the account. The transmitting unit 31a transmits information relating to reservation of a meeting room to the chat server 10 and transmits the reservation information to the meeting room terminal 90. The communication unit 31 performs bidirectional communication with the bidirectional communication apparatus 130.

The information associating unit 32 mainly performs processing relating to a preliminary registration process. Specifically, the information associating unit 32 receives a request for registering a domain from the registration terminal 50 or the like operated by the administrator, and registers the domain in a customer domain DB 495. Further, the information associating unit 32 stores the workspace and the channel of the chat system transmitted from the registration terminal 50 or the like in association with the account of the reservation management server 20 in an association information DB 491.

The reservation information obtainer 33 designates an account of a customer who uses the resource reservation system 100 to obtain the reservation information from the reservation management server 20. The reservation information obtainer 33 registers the obtained reservation information as meeting management information in a meeting management information DB 493. For example, the reservation information obtainer 33 designates an account of reservation information that is registered or updated notified from the reservation management server 20. Alternatively, the reservation information obtainer 33 designates an arbitrary account. At least a part of the reservation information stored in the reservation management server 20 is stored in the meeting management information DB 493. More specifically, the reservation information obtainer 33 obtains the reservation information for a predetermined period in the future from the current time among the reservation information stored in the reservation management server 20. The predetermined period is determined depending on how long a period ahead is set to future meetings for which the information about the reservation of the meeting room 6 is to be notified.

The notification determination unit 34 determines whether the meeting management information includes a reservation whose start time satisfies a condition for notification. For example, the notification determination unit 34 refers to a notification settings DB 496 to determine whether the current time matches a date and time obtained by subtracting a preset period from the start time of the reservation. When the current time matches the obtained date and time by this subtraction, the notification determination unit 34 determines that a notification is to be sent. In another example, at the time when the reservation information obtainer 33 acquires the reservation information from the reservation management server 20, the notification determination unit 34 generates a task for notifying information relating to the reservation and registers the task in the queue. The task stored in the queue is executed when the execution time (the time at which a reminder is to be sent) arrives.

For example, when there are plural bots according to different roles, such as a bot for sending a reminder or a bot for receiving a reservation, the notification determination unit 34 determines a suitable bot according to processing to be performed.

When the notification determination unit 34 determines that the notification is to be sent, the meeting information notification unit 37 designates information identifying the bot (e.g., a token in Slack) and information identifying the group as the notification destination, to request the chat server 10 to transmit a notification of the information about the reservation of the meeting room 6. Note that the notification is performed several times, and the meeting identification information is included in at least one of the notifications. The meeting identification information is information based on which the meeting management server 30 confirms whether the participant has a right to use the reserved meeting room 6 during the reserved time slot. The meeting information notification unit 37 generates the meeting identification information by the final notification at the latest. The meeting identification information is registered in a meeting identification information DB 494.

The control information generator 35 refers to the meeting management information to generate control information for the electronic device 70, and registers the generated control information in a control information DB 497. For example, the control information generator 35 generates control information for turning on the power of the electronic device 70 several minutes before the start time of the meeting. Further, the control information generator 35 generates control information for turning off the power of the electronic device 70 in response to detection of the check-out. The control information is stored in the control information DB 497.

In response to receiving an inquiry from the meeting room terminal 90 provided in the meeting room 6 as to whether there is control information, the control information response unit 36 refers to the control information DB 497 to transmit the control information corresponding to the meeting room 6 to the meeting room terminal 90.

The check-in management unit 38 manages a check-in and a check-out to and from a meeting room. Further, the check-in management unit 38 registers, in the meeting management information DB 493, a status of a meeting, which status changes according to the check-in and the check-out. The check-in is allowed when it is 5 to10 minutes before the start time of the meeting identified by the reservation ID. Further, the check-in is permitted when a pair of the meeting room ID and the meeting identification information transmitted from the meeting room terminal 90 is registered in the meeting identification information DB 494.

The device communication unit 39 acquires device information from the management apparatus 110 and communicates with the meeting room terminal 90 via the bidirectional communication apparatus 130. A detailed description is given later of the device information.

The reservation information transmitting unit 41 transmits reservation information (meeting management information) stored in the meeting management information DB 493 in response to a request from the meeting room terminal 90. The reservation information transmitting unit 41 can transmit the reservation information (the meeting management information) in the JSON format, the XML format, the CVS (Comma-Separated Values) format, or the like. Since the reservation information is repeatedly transmitted, a format having a smaller data size is advantageous.

The meeting management server 30 further includes a storage unit 49. The storage unit 49 is implemented by, for example, the memory 202 and the HDD 209 of FIG. 4. The storage unit 49 stores the association information DB 491, the meeting management information DB 493, the meeting identification information DB 494, the customer domain DB 495, the notification settings DB 496, the control information DB 497, and a meeting room setting information DB 498.

TABLE 3
Association Information DB

| | | Member | Member | Member | Member |
|---|---|---|---|---|---|
| Workspace | Channel | Account 1 | Account 2 | Account 3 | Account 4 |
| http://sample.com/1 | #marketing | a@xfood.com | b@xfood.com | c@xfood.com | d@xfood.com |
| | | a@chat.com | b@chat.com | c@chat.com | d@chat.com |
| http://sample.com/2 | #team1 | f@xfood.com | g@xfood.com | h@xfood.com | |
| | | f@chat.com | g@chat.com | h@chat.com | |
| . . . | . . . | . . . | . . . | . . . | . . . |

Table 3 illustrates an example data structure of association information stored in the association information DB 491. The association information is information associating the account of the reservation management system with the group of the chat system. The association information includes items of the workspace, the channel and the member accounts 1 to n (n=4 in Table 3). The same description described above with reference to Table 2 of the workspace and the channel applies to the workspace and the channel of Table 3. In the member accounts 1 to n, the accounts of participants issued by the reservation management server 20 are registered. In addition to or in alternative to the accounts issued by the reservation management server 20, the accounts of the chat system can be registered in the association information, as indicated in Table 3. To send a notification to the group, information identifying the account, issued by the reservation management server 20, of the user who made a reservation of a meeting to the reservation management server 20 and information (in the present embodiment, the workspace and the channel name) identifying the group and channel of the notification destination will suffice. In other words, the accounts of all the members belonging to the group are not necessarily registered in the association information. However, the account information of the chat system of each individual user is required when sending a notification to the individual user. Accordingly, the account of the user of the chat system can also be registered in the association information, as indicated in Table 3.

TABLE 4
Meeting Management Information DB

| | Account of | | Meeting | | | Accounts of | |
|---|---|---|---|---|---|---|---|
| Reservation | reservation- | Meeting | Room | Start | End | expected | |
| ID | making user | name | ID | time | time | participant | Status |
| 001 | a@xfood.com | Product Z | K-001 | 2017 Jul. 7 | 2017 Jul. 7 | b@xfood.com | Checked |
| | | development | | 10:00 | 12:00 | c@xfood.com | in |
| | | meeting | | | | d@xfood.com | |
| 002 | e@xfood.com | Product Y | K-001 | 2017 Jul. 7 | 2017 Jul. 7 | f@xfood.com | Notified |
| | | development | | 13:00 | 14:00 | g@xfood.com | |
| | | meeting | | | | | |
| . . . | . . . | . . . | . . . | . . . | . . . | . . . | . . . |

Table 4 illustrates an example data structure of the meeting management information stored in the meeting management information DB 493 of the meeting management server 30. Since the reservation information is included in the management information stored in the meeting management information DB 493, in the following description of Table 4, differences from the reservation information DB 291 of Table 1 are described. The meeting management information of Table 4 includes items of a reservation-making user's name, a reservation-making user's department name, a participant's name, a participant's department name, and a status. The reservation-making user's name is a name of a user who made the reservation. The reservation-making user's department name is a name of a department to which the user who made the reservation belongs. The participant's name is a name or the like of a participant. The participant's department name is a name of a department to which the participant belongs. Since the meeting management server 30 holds or can use user information associating the account with the name, the department name or the like, when the account is obtained, the name and the department name are identified. It should be noted that at the time when the reservation information is transmitted from the reservation management server 20, the reservation information can include the reservation-making user's name, the reservation-making user's department name, the participant's name, and the participant's department name.

The status indicates the status of a reservation. For example, the status registered in the meeting management information of Table 4 indicates whether a notification of the information about the reservation of the meeting room 6 has been sent, whether the use of the meeting room has been confirmed, whether the check-in operation has been performed, whether the check-out operation has been performed, or whether the reservation has been cancelled.

TABLE 5
Meeting Identification Information DB

| | | Meeting identification |
|---|---|---|
| Reservation ID | Meeting room ID | information |
| 001 | K-001 | 1234 |
| 002 | K-002 | 5678 |
| . . . | . . . | . . . |

Table 5 illustrates an example data structure of meeting identification information management information stored in the meeting identification information DB 494. The meeting identification information management information is information for managing the meeting identification information for each reservation of the meeting room 6. The meeting identification information management information includes items of the reservation ID, the meeting room ID, and the meeting identification information. The reservation ID, the meeting room ID, and the meeting identification information of the meeting identification information management information in Table 5 are the same or substantially the same as those of the reservation information (the reservation information acquired from the reservation management server 20), which further includes the status. Accordingly, the redundant descriptions thereof are omitted. It should be noted that the reservation ID is registered in order to identify the reservation of the same meeting room 6.

TABLE 6
Customer Domain DB

| Customer domain name | Customer administrator's account |
|---|---|
| xfood.com | a@xfood.com |
| ycar.com | f@ycar.com |
| . . . | . . . |

Table 6 illustrates an example data structure of customer domain information stored in the customer domain DB 495. The customer domain information is information for managing a customer's domain and an account of an administrator of the customer. The customer domain information stores a domain name of a customer in association with an administrator's account. The domain of the customer in Table 6 is the domain of the account (e-mail address) issued by the reservation management server 20. The administrator's account is an account of an administrator (representative) of the customer. The reservation management server 20 issues the accounts in Table 6.

TABLE 7
Notification Settings DB

| Customer domain name | Notification setting |
|---|---|
| xfood.com | One day before |
| ycar.com | 12 hours before |
| . . . | . . . |

Table 7 illustrates an example data structure of notification setting information stored in the notification settings DB 496. The notification setting information includes, for each of the customers, settings relating to a notification. The notification setting information stores the domain name of the customer in association with a notification setting. The notification setting indicates a timing at which the information about the reservation of the meeting room 6 is notified. In this example, the timing defines how long ahead the start time of the meeting the notification of the information about the reservation of the meeting room is to be sent. In another example, a fixed date and time can be set to the notification setting. Further, the number of the timings set in the notification setting is not necessarily one. In another example, a plurality of notification settings can be set in association with one customer.

TABLE 8
Control Information DB

| Meeting room ID | Control content |
|---|---|
| K-001 | Power ON |
| K-002 | Power Off |
| . . . | . . . |

Table 8 illustrates an example data structure of control information stored in the control information DB 497. The control information is information for controlling the electronic device 70 provided in the meeting room 6. The control information includes items of the meeting room ID and a control content. The control content is information indicating how the electronic device 70 is to be controlled. The meeting management server 30 can set a detailed control content for each electronic device 70. This control information does not include information indicating a time at which the electronic device 70 is to be controlled. This is because it is difficult for the meeting management server 30 to access the meeting room terminal 90, since the meeting management server 30 resides on the external network N2. Accordingly, the meeting room terminal 90 accesses the meeting management server 30. The meeting management server 30 transmits the control content, when the control information has already been generated when being accessed from the meeting room terminal 90.

TABLE 9
Meeting room setting information DB

| | | | | | | Number of |
|---|---|---|---|---|---|---|
| | | | State of | | | meeting room |
| | Meeting | | meeting | | | terminals |
| Customer | room | Meeting | room | Authentication | Management | that can be |
| ID | name | room ID | terminal | key | start flag | registered |
| G-001 | Meeting | K-001 | Connected | ***** | True | 1 |
| | room A | | | | | |
| | Meeting | K-002 | Before set-p | ***** | False | 1 |
| | room B | | | | | |
| | Meeting | K-003 | Disconnected | ***** | True | 2 |
| | room C | | | | | |

Table 9 illustrates an example data structure of meeting room setting information stored in the meeting room setting information DB 498. The meeting room setting information is information relating to settings of each meeting room. The meeting room setting information includes, in association with the customer ID, items of a meeting room name, the meeting room ID, a state of the meeting room terminal 90, an authentication key, a management start flag, and the number of meeting room terminals 90 that can be registered. The meeting room name is a general-purpose name of a meeting room recognized by participants attending in the meeting. Examples of the meeting room name include a name that is presented at the entrance of the meeting room. The meeting room ID is identification information for identifying a meeting room, as described above. In one example, the meeting room ID are common to the meeting room setting information and the reservation management server 20, to simplify the configuration and operation. In another example, a conversion table is provided that allows the administrator to set the different meeting room ID from that stored in the reservation management server 20. The state of the meeting room terminal 90 indicates whether the configuration of initial settings of the meeting room terminal 90 has been completed, whether communication is possible, and the like. “Connected” in the state of the meeting room terminal indicates a state in which communication is confirmed within a certain time period. “Before setup” in the state of the meeting room terminal indicates a state before the configuration of the initial settings of the meeting room terminal 90. “Disconnected” in the state of the meeting room terminal indicates a state in which no communication has been performed for equal to or longer than a certain time period. The authentication key is authentication information used by the meeting management server 30 to authenticate the meeting room terminal 90. The authentication key is transmitted to the meeting room terminal 90 by the initial settings. The authentication key is a combination of numbers, alphabets, symbols, and the like that are too long to be identified by the brute force attack. In one example, the meeting management server 30 determines the authentication key. In another example, the administrator determines the authentication key. The management start flag is a flag indicating whether the meeting management server 30 starts managing the meeting room after the configuration of the initial settings of the meeting room terminal 90 is completed. The value “true” set in the management start flag indicates that the meeting management server 30 starts managing the meeting room. The value “false” set in the management start flag indicates that the meeting management server 30 does not start managing the meeting room. The management start flag substantially eliminates inconveniences caused by a time lag from the time when the configuration of the initial settings is completed until the time when the meeting room terminal 90 is provided in the meeting room. The number of meeting room terminals 90 that can be registered indicates the number of meeting room terminals 90 that can be associated with one meeting room. It suffices that one meeting room terminal 90 is provided in one meeting room. However, in a case where any error occurs in the meeting room terminal 90, the user will have difficulty in checking in the meeting room until the repair of the meeting room terminal 90 is done. To address such situation, the administrator may want to associate plural meeting room terminals 90 with one meeting room. Therefore, even if the authentication key is revealed, since the terminal ID matches and the number of the meeting room terminals 90 is set in advance, reservation information is prevented from being revealed. The default value of the number of the meeting room terminals 90 can be either one or n (n≥2).

In one example, the meeting room name and the meeting room ID are determined in advance. In another example, the administrator sets the meeting room name and the meeting room ID. In still another example, the meeting room name and the meeting room ID transmitted from the reservation management server 20 are used. The default value (the value immediately after setting by a provider) of the state of the meeting room terminal 90 is “before setup”, but the value transitions according to the communication state. The value of the authentication key is assigned and set by the meeting management server 30 at the time of initial settings, for example. The management start flag is set by the administrator via a setting screen described later. The value of the number of meeting room terminals 90 that can be registered is also set by the administrator. In most cases, the value of the number of meeting room terminals 90 that can be registered is equal to or more than one. When the value of the number of meeting room terminals 90 that can be registered is set to one, only one meeting room terminal 90 can be registered in one meeting room.

Registration Terminal:

The registration terminal 50 includes a communication unit 51, an operation reception unit 52, and a display control unit 53. These functional units of the registration terminal 50 are functions or means that are implemented by operating one or more hardware components illustrated in FIG. 4 in cooperation with instructions of the CPU 201 according to the program 209p loaded from the HDD 209 to the memory 202. The program 209p can be distributed from a server for program distribution. Alternatively, the program 209p can be distributed on a storage medium.

The registration terminal 50 is a terminal, by using which the administrator configures various settings to the meeting room via a web page provided by the meeting management server 30. The settings include the initial settings and changing the priority level of the control target applications 89. The registration terminal 50 is also a terminal, by using which the administrator configures various settings to the meeting room terminal 90 via a web page provided by the management apparatus 110. The functions of the communication unit 51, the operation reception unit 52, and the display control unit 53 of the registration terminal 50 are the same or substantially the same as those of the terminal apparatus 60. A detailed description thereof will be given below, with reference to the description of the terminal apparatus 60.

Terminal Apparatus:

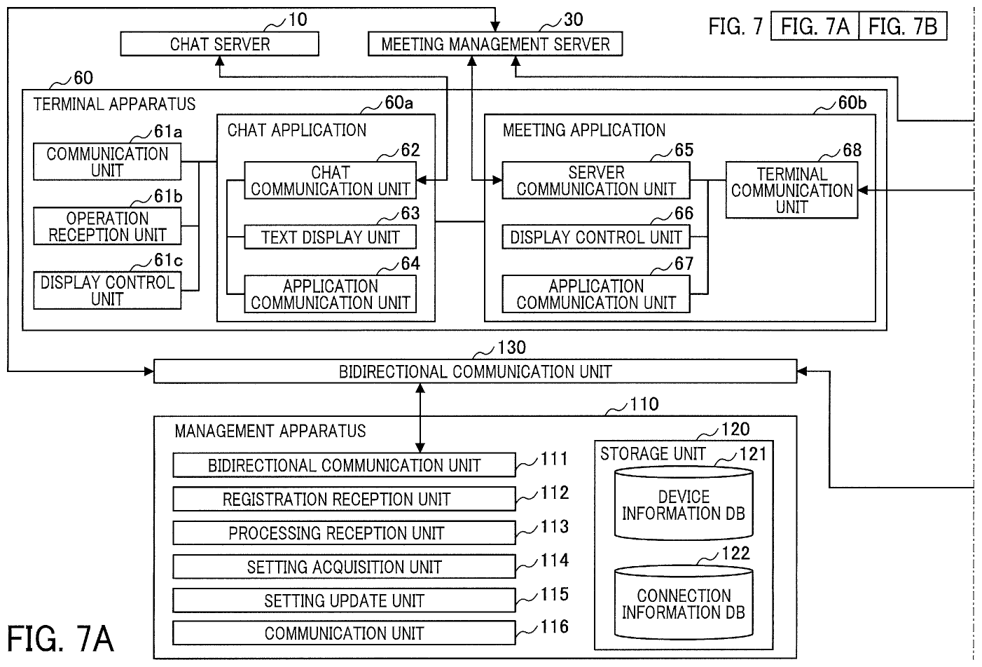

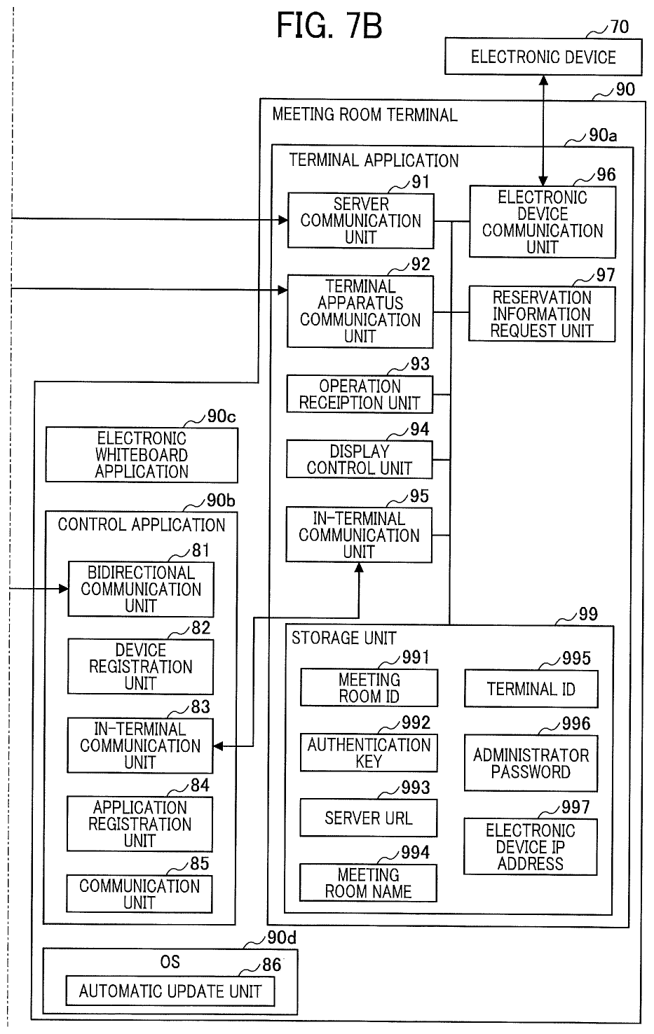

FIGS. 7A and 7B are a block diagram illustrating functional configurations of the terminal apparatus 60, the meeting room terminal 90, and the management apparatus 110. The functions of the electronic device 70 will be described as needed.

The terminal apparatus 60 includes a communication unit 61a, an operation reception unit 61b, a display control unit 61c, a chat communication unit 62, a text display unit 63, an application communication unit 64, a server communication unit 65, a display control unit 66, an application communication unit 67, and a terminal communication unit 68. These functional units of the terminal apparatus 60 are functions or means that are implemented by operating one or more hardware components illustrated in FIG. 4 in cooperation with instructions of the CPU 201 according to the program 209p loaded from the HDD 209 to the memory 202. The program 209p can be distributed from a server for program distribution. Alternatively, the program 209p can be distributed on a storage medium. Since a chat application 60a and a meeting application 60b operate on the terminal apparatus 60, the program 209p includes the chat application 60a and the meeting application 60b.

The communication unit 61a transmits and receives various types of information to and from the meeting management server 30 and the reservation management server 20. The communication unit 61a is implemented by the CPU 201 of FIG. 4 executing the program 209p to control the network driver 205.

The operation reception unit 61b receives various operations input by the participant to the terminal apparatus 60. The operation reception unit 61b is implemented by the CPU 201 of FIG. 4 executing the program 209p to control the input device 210.

The display control unit 61c interprets screen information of various screens to display screens on the LCD 206. The operation reception unit 61b and the display control unit 61c have, for example, a browser function and can execute a web application. For example, the display control unit 61c displays a reservation setting screen received from the reservation management server 20, and the operation reception unit 61b receives reservation information set by a user who is to make a reservation.

The chat communication unit 62 of the chat application 60a transmits and receives various types of information to and from the chat server 10. In the present embodiment, the chat communication unit 62 receives information about the reservation of the meeting room 6 from the chat server 10. Further, the chat communication unit 62 sends, to the chat server 10, a notification indicating that a message of the information about the reservation of the meeting room 6 has been read and a notification indicating whether the meeting room 6 is to be used or canceled. The chat communication unit 62 is implemented by the CPU 201 of FIG. 4 executing the program 209p to control the network driver 205.

The text display unit 63 of the chat application 60a displays text (the information about the reservation of the meeting room 6) transmitted from the chat server 10. For example, the text display unit 63 displays the text as if a source from which a comment is entered is the bot and the bot inputs the text. The text display unit 63 is implemented by the CPU 201 of FIG. 4 executing the chat application 60a.

The application communication unit 64 of the chat application 60a calls the meeting application 60b and transmits the meeting identification information to the meeting application 60b. The chat server 10 transmits information identifying the meeting application 60b to the terminal apparatus 60, when notifying the terminal apparatus 60 of the information about the reservation of the meeting room 6. Accordingly, the chat application 60a designates the meeting application 60b to the OS and requests notification of the meeting identification information. The OS activates the meeting application 60b. The application communication unit 64 is implemented by the CPU 201 of FIG. 4 executing the chat application 60a.

The server communication unit 65 of the meeting application 60b communicates with the meeting management server 30. For example, the server communication unit 65 obtains a two-dimensional code including the meeting identification information from the meeting management server 30. The server communication unit 65 is implemented by the CPU 201 of FIG. 4 executing the meeting application 60b. The two-dimensional code is used for authentication at check-in. Instead of or in addition to the two-dimensional code, numbers of a several digits can be used for authentication.

The display control unit 66 of the meeting application 60b displays the two-dimensional code or the like including meeting identification information on the LCD 206. The display control unit 66 is implemented by the CPU 201 of FIG. 4 executing the meeting application 60b to control the graphics driver 204.

The application communication unit 67 of the meeting application 60b obtains various kinds of information from the chat application 60a via the OS. Examples of the various kinds of information obtained from the chat application 60a include the meeting identification information included in the information about the reservation of the meeting room 6. The application communication unit 67 is implemented by the CPU 201 of FIG. 4 executing the meeting application 60b.

The terminal communication unit 68 communicates with the meeting room terminal 90 to transmit the meeting identification information, etc. The terminal communication unit 68 detects the meeting room terminal 90 using a short-range wireless communication network such as Bluetooth (registered trademark). In response to detecting the meeting room terminal 90, the terminal communication unit 68 transmits the meeting identification information to the detected meeting room terminal 90. Further, the terminal communication unit 68 provides a function of displaying the two-dimensional code to the meeting room terminal 90. The terminal communication unit 68 is implemented by the CPU 201 of FIG. 4 executing the meeting application 60b.

Meeting Room Terminal:

In the meeting room terminal 90, the terminal application 90a, the control application 90b, and the electronic whiteboard application 90c, each of which operates on the OS 90d, are installed. Each of these applications include functions as illustrated in FIG. 7B. The electronic whiteboard application 90c is an application that enables handwriting input to the meeting room terminal 90. It is sufficient that at least the terminal application 90a is installed in the meeting room terminal 90. In addition, three or more control target applications 89 can be installed in the meeting room terminal 90.

The meeting room terminal 90 includes, as functions of the terminal application 90a, a server communication unit 91, a terminal apparatus communication unit 92, an operation reception unit 93, a display control unit 94, an in-terminal communication unit 95, an electronic device communication unit 96, and a reservation information request unit 97. These functional units of the meeting room terminal 90 are functions or means that are implemented by operating one or more hardware components illustrated in FIG. 5 in cooperation with instructions of the CPU 601 according to the program 604p expanded from the EEPROM 604 to the RAM 603. The program 604p can be distributed from a server for program distribution. Alternatively, the program 604p can be distributed on a storage medium.

The server communication unit 91 communicates with the meeting management server 30 with a server URL 993 as a destination. Since the meeting room terminal 90 resides on the intra-company network N1, accessing from the meeting management server 30 to the meeting room terminal 90 is difficult (when the bidirectional communication apparatus 130 is not used). For this reason, the server communication unit 91 polls the meeting management server 30 to periodically communicate with the meeting management server 30. In addition to or in alternative to the polling, the server communication unit 91 communicates with the meeting management server 30 using a communication technology such as WebSocket. The server communication unit 91 performs the communication using a communication protocol such as HTTP. Any other suitable communication protocol other than HTTP can be used.

In the present embodiment, the server communication unit 91 receives the reservation information. Further, the server communication unit 91 transmits, to the meeting management server 30, the meeting identification information, which is received by the terminal apparatus communication unit 92 from the terminal apparatus 60 or is manually input at check-in. Furthermore, the server communication unit 91 receives the control information from the meeting management server 30. Further, the server communication unit 91 can bidirectionally communicate with the management apparatus 110 via the bidirectional communication apparatus 130.

The terminal apparatus communication unit 92 communicates with the terminal apparatus 60. In the present embodiment, the terminal apparatus communication unit 92 receives the meeting identification information, etc. When the meeting identification information is manually input, the terminal apparatus communication unit 92 can be omitted. The terminal apparatus communication unit 92 is implemented by the CPU 601 of FIG. 5 executing the program 604p to the short-range wireless communication device 615 or the RF tag reader/writer 622.

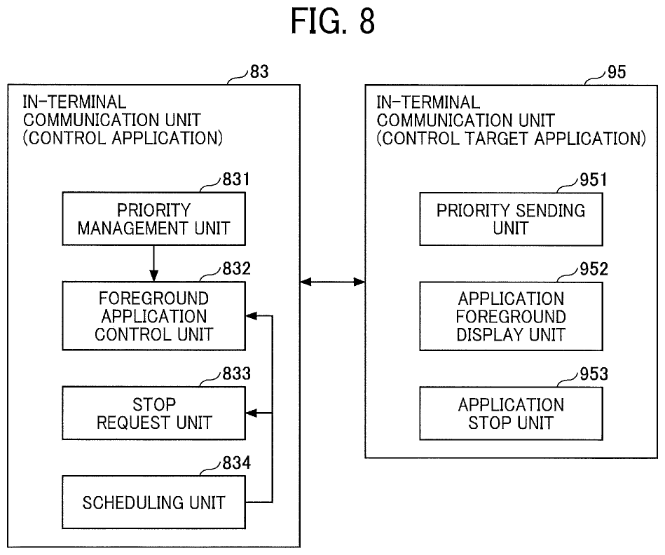

The in-terminal communication unit 95 communicates with other applications installed in the meeting room terminal 90. Examples of the other applications include the electronic whiteboard application 90c and the control application 90b. The in-terminal communication unit 95 can use the functions of the OS as needed to communicate with other applications. A detailed description is given later of functions of the in-terminal communication unit 95, with reference to FIG. 8.

The electronic device communication unit 96 communicates with the electronic device 70. In the present embodiment, the electronic device communication unit 96 transmits, to the electronic device 70, the control information received by the server communication unit 91. The electronic device communication unit 96 is implemented by the CPU 601 of FIG. 5 executing the program 604p to control the wireless LAN communication device 613.

The display control unit 94 displays a screen generated by the terminal application 90a on the display 616. This screen displayed by the display control unit 94 is a standby screen that receives a check-in and a check-out. The display control unit 94 according to the present embodiment determines whether a private setting is associated with the reservation information. When the private setting is associated with the reservation information, the display control unit 94 hides a private target item indicated by the private setting or replaces the private target item with a preset expression.

The operation reception unit 93 receives various operations input to the meeting room terminal 90. For example, the operation reception unit 93 receives a check-in, a manual input of the meeting identification information, and a check-out.

At periodical timings when the reservation information is to be acquired, the reservation information request unit 97 transmits, to the meeting management server 30, a meeting room ID 991 and an authentication key 992 via the server communication unit 91. The meeting management server 30 as a destination to which the meeting room ID 991 and the authentication key 992 are to be transmitted is specified by the server URL 993 stored in a storage unit 99. As a response to the transmission of the meeting room ID 991 and the authentication key 992, the reservation information request unit 97 acquires the reservation information via the server communication unit 91. It is sufficient that the reservation information be acquired when any change is made in the reservation information. Examples of the periodical timings when the reservation information request unit 97 acquires the reservation information include from every several seconds to every several minutes. The shorter the periodical timings, the sooner the reservation information updated. However, The shorter the periodical timings, the larger the communication load. Accordingly, the periodical timings are determined in view of both the update frequency of the reservation information and the communication load. In the embodiment, the reservation information request unit 97 acquires the reservation information every thirty seconds, for example. Further, the reservation information request unit 97 receives at least the meeting management information (reservation information) of the meeting room 6 of the current day via the server communication unit 91.

The meeting room terminal 90 further includes the storage unit 99. The storage unit 99 is implemented by, for example, the ROM 602 and the EEPROM 604 of FIG. 5. The storage unit 99 stores the meeting room ID 991, the authentication key 992, the server URL 993, a meeting room name 994, a terminal ID 995, an administrator password 996, and an IP address 997 of the electronic device 70. The above items constitute a part or an entirety of the setting information that is set in the meeting room terminal 90 (the terminal application 90a). The meeting room ID 991, the authentication key 992, and the server URL 993 are information necessary for communication with the meeting management server 30.

The terminal ID 995 is identification information identifying the meeting room terminal 90. The terminal ID is used by the meeting management server 30 to identify the meeting room terminals 90 in order to prevent more than a preset number of meeting room terminals 90 from being connected to the meeting management server 30 in one meeting room. Examples of the terminal ID include a universally unique identifier (UUID) of the terminal application 90a and a MAC address. Any other suitable information can be used as the terminal ID, provided that the information is unique. The UUID is a unique identifier in a sense that two or more items do not have the same value all over the world without specific management. The administrator password 996 is set by the administrator when the terminal application 90a is installed or when the terminal application 90a is activated for the first time. The IP address 997 of the electronic device 70 is set by the administrator as needed.

The meeting room terminal 90 further includes, as functions of the control application 90b, a bidirectional communication unit 81, a device registration unit 82, an in-terminal communication unit 83, an application registration unit 84, and a communication unit 85.

The bidirectional communication unit 81 performs bidirectional communication with the management apparatus 110 or the meeting management server 30 via the bidirectional communication apparatus 130. The device registration unit 82 registers the device information to the management apparatus 110 and the bidirectional communication apparatus 130 in response to the installation of the control application 90b in the meeting room terminal 90. The in-terminal communication unit 83 bidirectionally communicates with the in-terminal communication unit 95 of the terminal application 90a. A detailed description is given later of functions of the in-terminal communication unit 83, with reference to FIG. 8.

The application registration unit 84 registers information relating to an application installed in the meeting room terminal 90 in the management apparatus 110. The communication unit 85 connects to the intra-company network N1, to communicate with extraneous sources without the bidirectional communication apparatus 130.

Management Apparatus:

The management apparatus 110 includes a bidirectional communication unit 111, a registration reception unit 112, a processing reception unit 113, a setting acquisition unit 114, a setting update unit 115, and a communication unit 116. These functional units of the management apparatus 110 are functions or means that are implemented by operating one or more hardware components illustrated in FIG. 4 in cooperation with instructions of the CPU 201 according to the program 209p loaded from the HDD 209 to the memory 202.

The bidirectional communication unit 111 performs bidirectional communication with the meeting room terminal 90 via the bidirectional communication apparatus 130. The registration reception unit 112 receives a request for registering the device information and the information relating to the application from the control application 90b. In response to receiving the request, the registration reception unit 112 registers the device information and the information relating to the application in a device information DB 121 or a connection information DB 122.

The processing reception unit 113 generates screen information of a remote setting screen described later and transmits the generated screen information to the registration terminal 50 via the communication unit 116. The screen information is generated by Hyper Text Markup Language (HTML), Cascade Style Sheet (CSS), JavaScript (registered trademark), or the like. The remote setting screen is provided as one screen of a web application that operates on a browser by JavaScript (registered trademark).

In response to a request from the meeting management server 30 or the administrator (the registration terminal), the setting acquisition unit 114 acquires setting information of the terminal application 90a and the priority level that the control application 90b includes via the bidirectional communication apparatus 130. In response to a request from the meeting management server 30 or the administrator (the registration terminal), the setting update unit 115 updates the setting information of the terminal application 90a and the priority level that the control application 90b includes via the bidirectional communication apparatus 130. The communication unit 116 connects to the external network N2, to communicate with extraneous sources without the bidirectional communication apparatus 130.

Further, the management apparatus 110 further includes a storage unit 120. The storage unit 120 is implemented by, for example, the memory 202 and the HDD 209 of FIG. 4. The storage unit 120 stores the device information DB 121 and the connection information DB 122.

TABLE 10

| | | MAC | Installed | Application |
|---|---|---|---|---|
| No. | Device ID | address | application ID | version |
| 1 | ABC | XXXX | jp.co.aaaaa.aap1 | 1.0 |
| | | | jp.co.aaaaa.aap2 | 1.1 |
| 2 | DEF | YYYY | jp.co.aaaaa.aap1 | 0.9 |
| 3 | GHI | ZZZZ | jp.co.aaaaa.aap3 | 1.5 |

Table 10 illustrates an example data structure of the device information stored in the device information DB 121. The device information includes a serial number assigned to each record. The device information further includes a MAC address, an installed application ID, and an application version in association with a device ID. The device ID is information for identifying or specifying the meeting room terminal 90 (or the control application 90b). The MAC address is a physical address that is uniquely assigned to hardware of a network device such as a LAN card set to identify each node (the meeting room terminal 90) on a network. The installed application ID is identification information for identifying or specifying an application (the terminal application 90a, the control application 90b, the electronic whiteboard application 90c, etc.) installed in the meeting room terminal 90. The application version is the version of each of the installed applications.

Among the device information, the device ID or a combination of the device ID and the application ID is communication information, by using which the management apparatus 110 communicates with the meeting room terminal 90. In another example, the communication information includes the connection ID described later. In the present embodiment, the communication information is implemented by the device ID.

TABLE 11

| No. | Device ID | Connection ID | Connection state |
|---|---|---|---|
| 1 | ABC | 1111 | Disconnected |
| 2 | ABC | 2222 | Connected |
| 3 | DEF | 3333 | Connected |
| 4 | GHI | 4444 | Connected |

Table 11 illustrates an example data structure of the connection information stored in the connection information DB 122. The connection information includes a serial number assigned to each record. The device information further includes a connection ID and a connection status in association with the device ID. The connection ID is information, by using which the bidirectional communication apparatus 130 determines whether the management apparatus 110 is authorized to communicate with the meeting room terminal 90. Such information is sometimes referred to as an “access token”. In the connection status, information is registered that indicates the communication state (connected or disconnected) between the management apparatus 110 and the meeting room terminal 90. The connection ID can be the communication information, by using which the management apparatus 110 communicates with the meeting room terminal 90.

OS:

The OS 90d includes an automatic update unit 86. The automatic update unit 86 communicates with the application server 140, to download a new version of the control application 90b, the terminal application 90a, and/or the electronic whiteboard application 90c installed in the meeting room terminal 90 from the application server 140. Further, the automatic update unit 86 updates the old version of the application with the downloaded new version of the application. Note that the download of the new version and the update of the application are performed when the application is stopped.

Function of In-Terminal Communication Unit:

FIG. 8 is a block diagram illustrating the functional configurations of the in-terminal communication unit 83 and the in-terminal communication unit 95. As described above, the in-terminal communication unit 83 of the control application 90b and the in-terminal communication unit 95 of the control target application 89 can communicate inside the meeting room terminal 90. For example, an OS called Android (registered trademark) has a function called intent communication.

First, the in-terminal communication unit 83 of the control application 90b includes a priority management unit 831, a foreground application control unit 832, a stop request unit 833, and a scheduling unit 834. The priority management unit 831 acquires a priority level from the control target applications 89, to determine an application to be displayed in the foreground. The priority management unit 831 manages the priority level in association with the control target applications 89. In another example, the priority management unit 831 obtains the priority level of the control target application 89 from the management apparatus 110.

The foreground application control unit 832 sends, to the control target application 89 having the highest priority level, a notification indicating that such control target application 89 is to be displayed in the foreground, based on a schedule that is determined in advance. This schedule is managed by the scheduling unit 834. Since the foreground application control unit 832 repeatedly (for example, periodically) sends the notification indicating that the control target application 89 is to be displayed in the foreground, the control target application 89 having the highest priority level can be kept being displayed in the foreground.

The stop request unit 833 sends a notification indicating stop to the control application 90b based on a schedule that is determined in advance. This schedule is managed by the scheduling unit 834. In response to the notification of the stop, although the control application 90b does not include a start request unit for activating the control target application 89, the foreground application control unit 832 sends a notification indicating that the application is to be displayed in the foreground so that the control target application 89 that has been stopped starts up. In another example, the control application 90b can further include the start request unit.

The scheduling unit 834 includes settings of a daytime zone and a nighttime zone. In the daytime zone, the scheduling unit 834 causes the foreground application control unit 832 to perform control and does not cause the stop request unit 833 to perform control. In the nighttime zone, the scheduling unit 843 does not cause the foreground application control unit 832 to perform control and causes the stop request unit 833 to perform control. For example, the daytime and the nighttime are defined as 6:00 to 22:00 and 22:00 to 06:00, respectively. However, this is just an example, and any other suitable time zones can be set as the daytime and nighttime zones.

The in-terminal communication unit 95 of the control target application 89 includes a priority sending unit 951, an application foreground display unit 952, and an application stop unit 953. The priority sending unit 951 sends the priority level of the control target application 89 itself to the control application 90b. For example, the priority sending unit 951 sends the priority level when the control target applications 89 starts up or in response to receiving a request from the control application 90b.

In response to receiving the notification indicating that the application is to be displayed in the foreground from the control application 90b, the application foreground display unit 952 displays the control target application 89 in which the application foreground display unit 952 itself is included on top of applications. Accordingly, the control target application 89 in which the application foreground display unit 952 is included is displayed in the foreground. Although the control application 90b also has a screen (user interface), the control application 90b is an application that displays a home screen as described later. For this reason, the screen of the control target application 89 is displayed closer to the front than the screen of the control application 90b. Further, the control application 90b is not subject to priority comparison. In other words, no priority level is assigned to the control application 90b.

In response to receiving the notification indicating that the application is to be displayed in the foreground from the control application 90b, the application stop unit 953 stops the control target application 89 in which the application stop unit 953 itself is included. To “stop” an application means bringing the application into a state in which a user cannot use the application. However, in the present embodiment, to “stop” an application means bringing the application into a state in which the application can be updated. A detailed description is given later of the “stop”.

FIG. 8 illustrates an example in which the in-terminal communication unit 83 and the in-terminal communication unit 95 include the above-described functions. In another example, each of the control application 90b and the terminal application 90a can include the above-described functions.

Control Application:

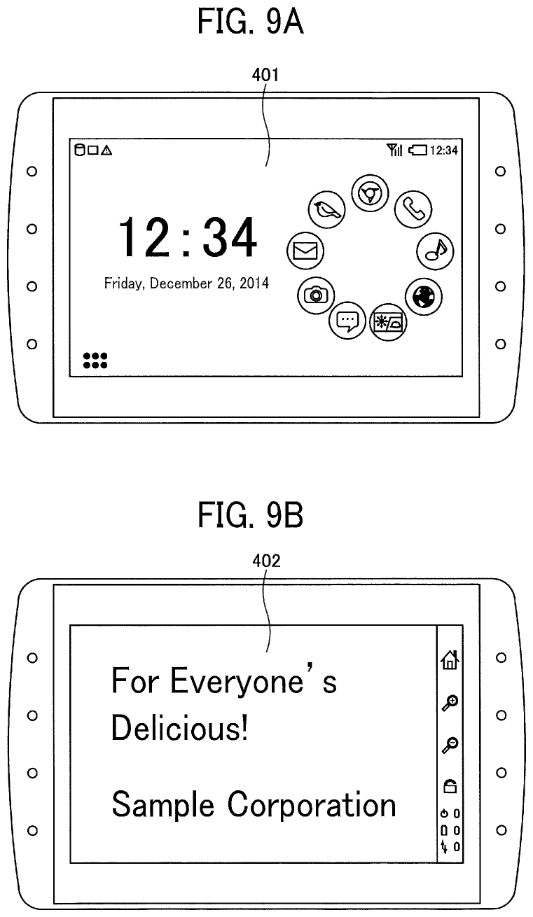

A description is given of an operation performed in a case where the control application 90b is a home application, with reference to FIGS. 9A and 9B. FIGS. 9A and 9B are diagrams, each illustrating an example of the home screen of the meeting room terminal 90. In an OS such as Android, a function of displaying the home screen is also implemented by a predetermined application. Such application implementing the function of displaying the home screen is called a “home application” to be distinguished from other applications. The home screen is a basic screen that is displayed immediately after the meeting room terminal 90 is turned on (or after login in a case where a lock screen is displayed). The home application displays the home screen.

FIG. 9A illustrates an example of a home screen 401, which is a general-purpose home screen, on which the time and date, and icons representing installed applications are displayed. In the present embodiment, the control application 90b displays the home screen 401. In other words, the control application 90b is the home application. Specifically, information indicating that the control application 90b is the home application is registered in the OS.

FIG. 9B illustrates an example of a home screen 402 displayed by the control application 90b. The design of the home screen 402 displayed by the control application 90b can be any desired design. Examples of a content displayed on the home screen 402 include company catchphrases, advertisements, and notification information to employees. A video can be reproduced on the home screen.

Therefore, in a case where there is no control target application 89 that is running or the control target applications 89 are hidden, the meeting room terminal 90 can display the home screen 402 under control of the OS. By contrast, when there is at least one control target application 89 that is running and such control target application 89 is not hidden, a screen of the control target application 89 to be displayed in the foreground is displayed on the home screen 402. Thus, since the control application 90b is a home application, the control application 90b is a resident application (resident application software) that is constantly kept in an operating state. In addition, an operation mode in which an application is resident and keeps operating but is not displayed may be referred to as a “background operation”.

The control application 90b is constantly kept in an operating state. This “constantly” includes a case in which the application is temporarily stopped but returns to an operation state in a timely manner. Therefore, control is performed that causes the control target application 89 to be displayed in the foreground.

As described above, the control application 90b is registered as a home application in the OS to constantly keep the control application 90b in an operating state. Instead of registering the control application 90b in the OS as the home application, to constantly keep the control application 90b in an operating state, a developer or the control application 90b can register, in the OS, a reservation of the restart of the control application 90b when the control application 90b is stopped. In this case, since the home screen 401 illustrated in FIG. 9A is displayed, the control application 90b may not have a screen to be displayed. The control application 90b can control the control target applications 89 while operating in the background.

Lifecycle of Application:

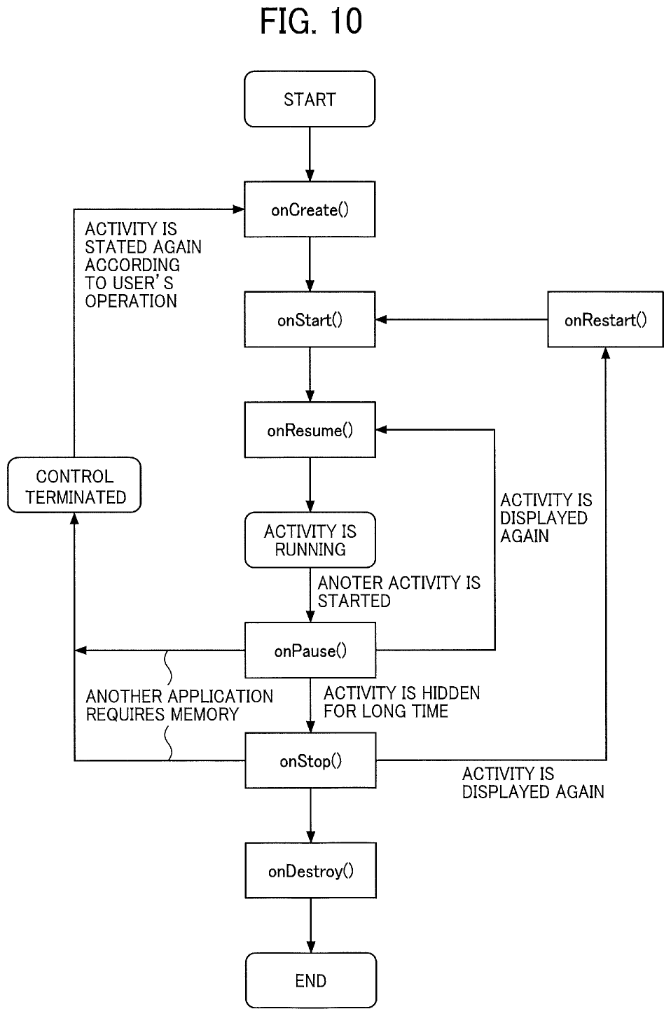

FIG. 10 illustrates an example a lifecycle of an application. With reference to FIG. 10, an example case is described in which an application is Android. In Android, an application screen that is visible to a user is called an “activity”. The activity can be treated as the lifecycle of the application. From the start of the activity to the destruction of the activity is called an “activity lifecycle”.

When the activity is launched (when an application is activated), the “onCreate method”, the “onStart method”, and the “onResume method” are called in sequence. As a result, the activity enters the “running” state.

When another activity (either the same application or another application) is activated, the “onPause method” is called. As a result, the first activity is hidden (becomes invisible) by another activity. If the state in which the first activity is not visible continues for a long time, the “onStop method” is called. As a result, the first activity enters the “stopped” state. Even after the “onPause method” is called, if the “onResume method” is called before the “onStop method” is called, the first activity is displayed.

Although the activity is not displayed in the “stopped” state, the activity is not yet terminated (the process no longer resides in a memory). For example, when the user performs an operation to cause the hidden activity to be displayed again on the screen, the “onRestart method”, “onStart method”, and “onResume method” are called. As a result, the activity transitions to the “running state” again.

When the “onDestroy method” is called while the activity is in the “stopped” state, the activity terminates (there is no process in a memory). For example, this state corresponds to a case in which the activity is terminated by a specific operation from the user.

During the “stopped” state or the state where the “onPause method” has been called, the activity is sometimes terminated due to insufficient memory. In this case also, the activity terminates (the process no longer resides in a memory).

As described, even when the application is not displayed on the screen, the application is in one of the two states, i.e., the stopped state and the termination. In the present embodiment, the stopped state and the termination are not particularly distinguished from one another. In the present embodiment, to cause the application to enter a state in which the application can be updated is referred to as “stop”. The process can reside in the memory. Alternatively, control can be performed in a state in which no process resides in the memory. A process is a program execution unit. From the viewpoint from the CPU, the process is an execution unit of a code and data. From the viewpoint from the OS, the process is a management unit of memory.

In addition, the lifecycle illustrated in FIG. 10 is a lifecycle of Android. In other OSs than Android, to cause an application to enter a state in which the application can be updated in the lifecycle of the other OSs is referred to as “stop”.

Foreground Display Control:

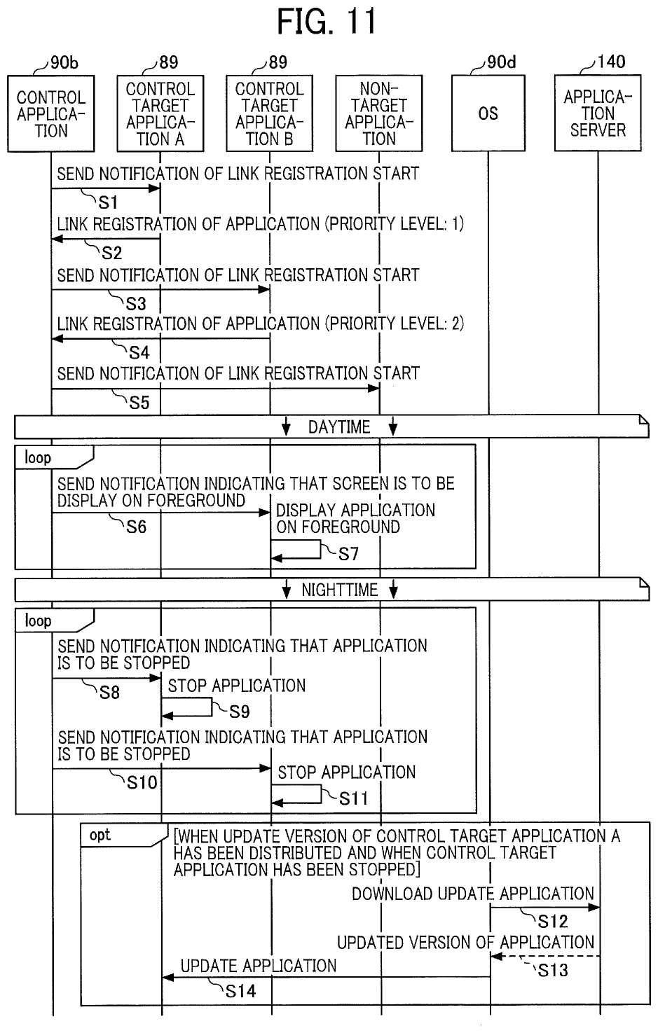

A description is given of control for displaying the control target applications 89 in the foreground, with reference to FIG. 11. FIG. 11 is a sequence diagram illustrating an example of an operation in which the control application 90b acquires the priority level and displays the control target application 89 in the foreground.

S1: When the control application 90b is launched, the in-terminal communication unit 83 of the control application 90b sends, to each application in the meeting room terminal 90, a link registration start notification indicating that a link registration is now available. The link registration start notification includes identification information of the control application 90b as a transmission source of the notification. The link registration start notification is transmitted to unspecified applications (may be transmitted via the OS). A setting as to whether to receive this notification is configured in each application. Therefore, when transmitting the link registration start notification, the control application 90b does not recognize which application is to be linked. Android supports implicit intents. An implicit intent specifies an action and data (URI) and is broadcasted. An intent filter is set in advance in each control target application 89 that is ready to be controlled by the control application 90b. Each control target application 89, which can receive the specified action and data, responds to the link registration start notification. Therefore, even if the user downloads a given application to the meeting room terminal 90, such downloaded application does not respond to the link registration start notification.

In addition, since the control application 90b is a resident application, the frequency of activation of the control application 90b is not high. This means that the frequency of sending the link registration start notification is also low. However, as described later, since the control target application 89 sends a notification indicating the priority level when the control target application 89 is activated, thereby enabling the control application 90b to acquire the priority level at least once a day. Alternatively, the in-terminal communication unit 83 of the control application 90b can transmit the link registration start notification of step S1 at any timing other than when the control application 90b is activated, such as at periodical timings.

S2: In response to receiving the link registration start notification from the control application 90b, the priority management unit 831 of each control target application 89 sends, to the control application 90b, a notification indicating that the control target application 89 in which the priority management unit 831 is included is registered as a link target. The priority management unit 831 of the control target applications 89 sends the notification indicating the registration of the link target by specifying the identification information of the control application 90b or by specifying the identification information of the control target application 89 itself. Further, the priority sending unit 951 of the control target applications 89 sends the priority level of the control target applications 89 itself. In response to receiving the notification indicating the registration of the link target, the priority management unit 831 of the control application 90b recognizes the control target application 89 from which the notification is received as a link target. Further, the priority management unit 831 manages the priority of the control target application 89 in association with the identification information of the control target application 89.

S3, S4: The same or substantially the same processes as steps S1 and S2 are performed. FIG. 11 illustrates an example in which a control target application 89A transmits the priority level 1 and a control target application 89B transmits the priority level 2. Note that the larger the value of the priority level, the higher the priority.

S5: The control application 90b transmits the link start registration notification to an application which is not the link target. However, since the application which is not the link target does not transmit the notification indicating registration of the link target, such application is not registered in the control application 90b. In Android, since the above-described intent filter is not set in the application which is not the link target, the link registration start notification is not delivered to the application which is not the link target. Since the link registration start notification is not transmitted to the application which is not the link target, the application which is not the link target does not transmit the notification indicating registration of the link target.

Thereafter, when the control application 90b is in operation, the following processes are repeated at preset intervals. If the control application is in operation, the following processes are performed permanently.

S6: During the daytime, the scheduling unit 834 causes the foreground application control unit 832 to perform control. The foreground application control unit 832 designates the control target application 89 registered with the highest priority level, to transmit a foreground display notification to such control target application 89. In the present embodiment, since the priority level of the control target application 89B is higher than that of the control target application 89A, the foreground display notification is transmitted to the control target application 89B. The foreground application control unit 832 does not send the foreground display notification to the control target application 89 whose priority level is not highest.

However, in the present embodiment, it is sufficient that the control target application(s) 89 whose priority level is not highest priority is not displayed in the foreground. Therefore, the foreground application control unit 832 can activate only the process of the control target application 89 whose priority level is not highest and control such control target application 89 to operate in the background. In other words, the foreground application control unit 832 can control the lifecycle of such control target application 89 to be in the “stop” state.

S7: In response to receiving the foreground display notification, the application foreground display unit 952 of the control target applications 89B displays the control target application 89B itself in the foreground. For example, the “BringToFront method” is executed on Android. When the notification indicating the application is to be hidden transmitted to the control target application 89 whose priority level is not highest, for example, the “onPause method” or the “onStop method” can be executed because it is sufficient that such control target application 89 is hidden.

Since the foreground application control unit 832 transmit the foreground display notification at preset intervals, the control target application 89 that is to be displayed in the foreground is displayed in the foreground in a certain time, even when any other application is in operation or when the control target application 89 that is to be displayed in the foreground is not displayed. Even when a given application that is not a management target is displayed in the foreground, the control target application 89 (terminal application 90a) that displays the standby screen can be displayed in the foreground. Note that, the above does not apply to an exceptional case in which the OS controls which application is to be displayed in the foreground.

In another example, the foreground application control unit 832 sends an inquiry, to the OS or the like, as to whether the control target application 89 whose priority level is highest is displayed in the foreground. In this case, the foreground application control unit 832 transmits the foreground display notification only when the control target application 89 (terminal application 90a) having the highest priority level is not displayed in the foreground.

S8, S10: During the nighttime, the scheduling unit 834 causes the stop request unit 833 to perform control. The stop request unit 833 transmits a stop request notification to all the control target applications 89.

S9, S11: In response to receiving the stop request notification, the application stop unit 953 of each control target application 89 and stops the control target application 89 itself. In Android, the “finish” method or the “FinishAndRemoveTask” method is executed.

The transmission of the stop request notification is also performed at preset intervals. Accordingly, even when the control target application 89 is activated (for example, when the user activates the control target application 89 or when settings are configured so that the control target application 89 automatically starts up after update), the control target application 89 is stopped again. In another example, the stop request unit 833 detects whether each control target application 89 is currently stopped. In this case, when the stop request unit 833 transmits the stop request only when the detection result indicates that the control target application 89 is in operation.

S12: When the control target application 89 is stopped (i.e., during the nighttime) and when the updated version of the control target application 89 is distributed by the application server 140, the automatic update unit 86 of the OS executes automatic update. The automatic update unit 86 downloads the latest version of the control target application 89 (updated version of application) from the application server 140.

S13: The application server 140 transmits the latest version of the control target application 89 to the meeting room terminal 90.

S14: In response to receiving the latest version of the control target application 89, the automatic update unit 86 receives updates the control target application 89. As described above, the control application 90b stops each control target application 89 during the nighttime, thereby enabling the OS to update the control target application 89 if there is the latest version of the application that is not activated.

During the nighttime, the control target application 89 that is updated is stopped by the stop request notification. When it becomes daytime, the control target application is activated by the foreground display notification and kept being displayed in the foreground. The control application 90b does not need to perform update processing. In addition, regardless of whether the control target application 89 is updated, the control application 90b only needs to start or stop the control target application 89 according to time zones.

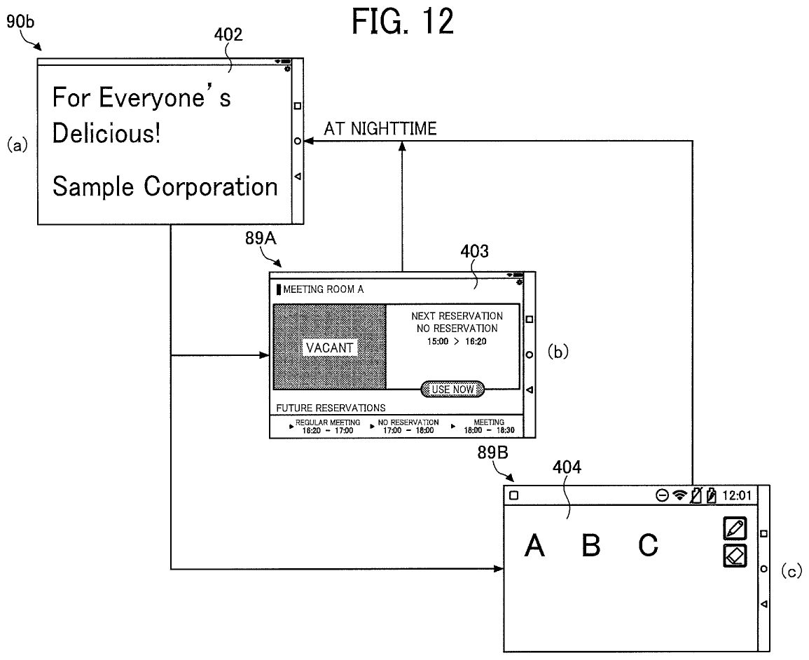

FIG. 12 is a diagram illustrating an example of how a screen of the meeting room terminal 90 transitions. Screen (a) of FIG. 12 is the home screen 402 displayed by the control application 90b. Screen (b) of FIG. 12 is a standby screen 403 displayed by the control target application 89A. Screen (c) of FIG. 12 is an operation screen 404 displayed by the control target application 89B.

During the daytime, either the standby screen 403 of the control target application 89A or the operation screen 404 of the control target application 89B is displayed in the foreground. More specifically, from among the control target application 89A and the control target application 89B, the application whose priority level is higher than the other is displayed in the foreground. Since all the control target applications 89 stop when it becomes nighttime, the home screen 402 generated by the control application 90b, which is an application that is always running, is displayed. When it becomes daytime again, the control target application 89 whose priority level is highest is activated and displayed in the foreground.

As described later, when the administrator or the like changes the priority levels of the control target applications 89, the control target application 89 displayed in the foreground is switched.

Automatic Registration of Meeting Room Terminal:

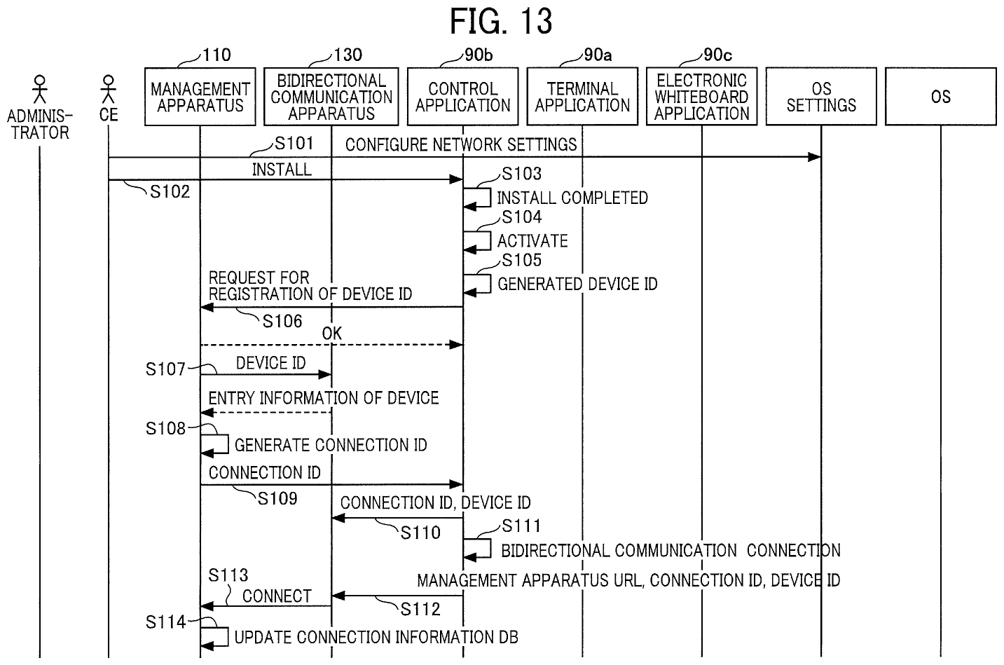

In order to enable the management apparatus 110 that resides on the cloud network to communicate with the meeting room terminal 90 that resides on the on-premises network, the meeting room terminal 90 needs to be registered in the management apparatus 110 and the bidirectional communication apparatus 130. Therefore, a description is now given of a procedure of automatic registration of the meeting room terminal 90, with reference to FIG. 13. FIG. 13 is a sequence diagram illustrating an example of an operation in which the control application 90b installed in the meeting room terminal 90 registers the meeting room terminal 90 and the application installed in the meeting room terminal 90 in the management apparatus 110.

S101: First, a customer engineer (CE) operates the OS of the meeting room terminal 90 to configure network settings. More specifically, the customer engineer configures settings such as a service set identifier (SSID), an SSID password, and the like.

S102: Next, the CE downloads the control application 90b from an application distribution website (server) and installs the downloaded control application 90b in the meeting room terminal 90. In another example, instead of the CE, a user of the system, an owner of the terminal or the administrator performs an operation for the configuration of settings of S101 and/or the installation of S102.

S103, S104: When the installation of the control application 90b completes, the control application 90b automatically starts up. Alternatively, the CE can activate the control application 90b.

S105: Triggered by the installation of the control application 90b, the device registration unit 82 of the control application 90b starts automatic registration of the meeting room terminal 90 in the management apparatus 110. The device registration unit 82 detects an installed application(s) from the OS or the like in advance. The device registration unit 82 generates a unique device ID. In another example, the management apparatus 110 generates the device ID.

S106: The device registration unit 82 specifies the device ID, to request the bidirectional communication apparatus 130 to register the device ID. In response to receiving the device ID, the bidirectional communication apparatus 130 registers the received device ID and sends a response indicating OK to the device registration unit 82.

S107: The bidirectional communication unit 111 of the management apparatus 110 transmits the device ID to the bidirectional communication apparatus 130. The bidirectional communication apparatus 130 transmits entry information of the device to the management apparatus 110. The entry information is information for registering the device.

S108: The bidirectional communication unit 111 of the management apparatus 110 receives the entry information, and the registration reception unit 112 generates a connection ID by using the entry information.

S109: The registration reception unit 112 of the management apparatus 110 transmits the connection ID to the control application 90b via the bidirectional communication unit 111.

S110: The bidirectional communication unit 81 of the control application 90b receives the connection ID, and the device registration unit 82 transmits the connection ID and the device ID to the bidirectional communication apparatus 130. Note that in a case where the connection ID includes information for specifying the device ID, there is no need to transmit the device ID. Through the processes described above, the control application 90b, the management apparatus 110, and the bidirectional communication apparatus 130 hold the device ID and the connection ID.

S111: When registration of the device information is completed, the bidirectional communication unit 81 of the control application 90b starts bidirectional communication with the management apparatus 110 (connects to the management apparatus 110) by using the connection ID.

S112: The bidirectional communication unit 81 of the control application 90b specifies the URL, the connection ID, and the device ID of the management apparatus 110, and send a request for connection with the management apparatus 110 to the bidirectional communication apparatus 130. The bidirectional communication unit 81 maintains communication between the control application 90b and the bidirectional communication apparatus 130 until the application is forcefully terminated. Note that when the control application 90b is terminated, the control application 90b automatically restarts up to perform device ID generation and connection ID acquisition again.

S113: The bidirectional communication apparatus 130 authenticates the combination of the connection ID and the device ID. When the authentication is successful, the bidirectional communication apparatus 130 connects to the URL of the management apparatus 110.

S114: The bidirectional communication unit 111 of the management apparatus 110 receives the device ID, and updates the connection state associated with the device ID in the connection information DB 122 to “Connected”. With the processes described above, the meeting room terminal 90 and the management apparatus 110 are connected via the bidirectional communication apparatus 130.

While the control application 90b and the bidirectional communication apparatus 130 are connected with each other, the bidirectional communication apparatus 130 uses a specific port (for example, 443) of the meeting room terminal 90 to perform HTTPS communication with the control application 90b by using the WebSocket. Thus, communication beyond the firewall is performed. Note that the administrator can specify a protocol such as HTTPS can by using the SDK library in the bidirectional communication apparatus 130.

While the control application 90b and the bidirectional communication apparatus 130 are connected with each other, the control application 90b also operates as a server. Therefore, the control application 90b configure settings and performs control in response to a request from the bidirectional communication apparatus 130.

Change of Priority Level:

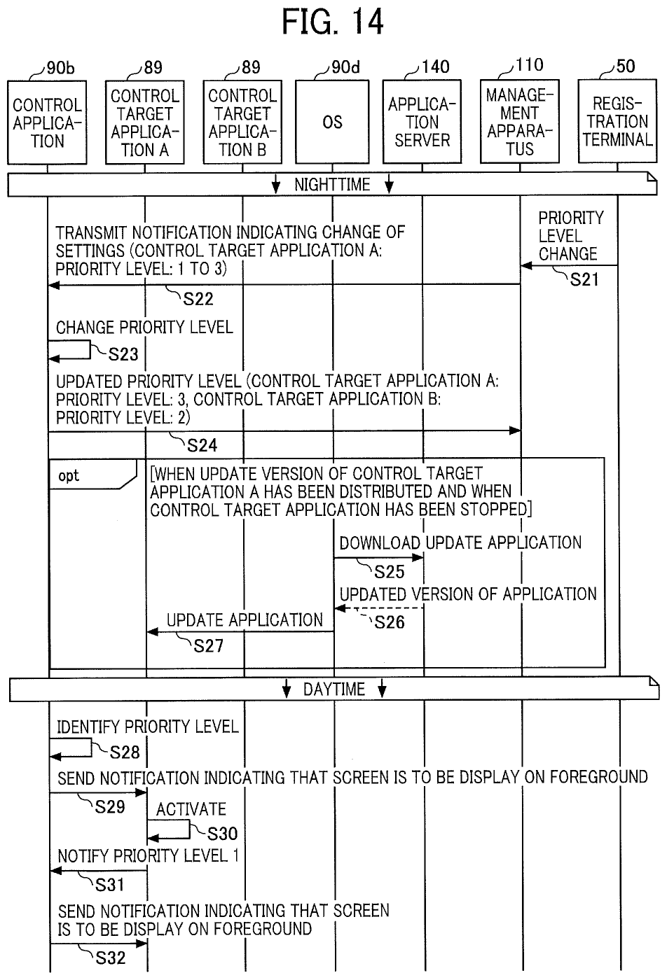

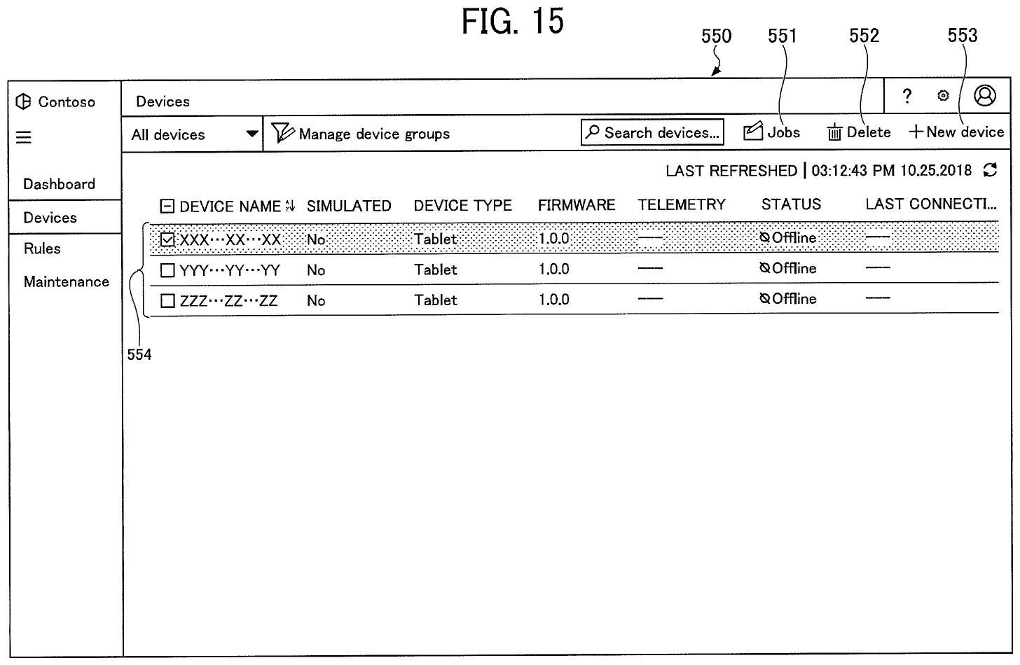

A description is now given of an operation of changing the priority levels of the control target applications 89 with reference to FIG. 14. FIG. 14 is a sequence diagram illustrating an example of an operation of changing the priority levels held by the control application 90b according to an operation by the administrator or the like and displaying the control target application 89 in the foreground.

S21: When the administrator wants to change the priority level of the control target application 89 (in other words, wants to change the control target application 89 to be displayed in the foreground), the administrator connects the registration terminal 50 to the management apparatus 110. The management apparatus 110 is a web server that provides a web application. Further, the management apparatus 110 performs bidirectional communication with the meeting room terminal 90 via the bidirectional communication apparatus 130. The registration terminal 50 displays the remote setting screen provided by the management apparatus 110. The administrator changes the priority levels of the control target application 89 on the remote setting screen. Further, the management apparatus 110 acquires the current priority level of each control target application 89 from the control application 90b. For example, the management apparatus 110 communicates with the meeting room terminal 90 in response to a request from the registration terminal 50, to obtain the current priority of level each control target application 89. In another example, when the priority level is changed, the management apparatus 110 acquires the updated priority level of the control target application 89. The administrator can check the priority level of each control target application 89 to determine which priority level should be set for each control target application 89.

Although in the example of FIG. 14, the priority level is changed during the nighttime, the priority level can be changed during the daytime.

For the sake of explanatory convenience, it is assumed that the current priory levels displayed on the registration terminal 50 are as follows:

Control target applications 89A: Priority level 1

Control target application 89B: Priority level 2

It is assumed that in this state, the administrator changes the priority level of the control target application 89A from 1 to 3.

S22: The processing reception unit 113 of the management apparatus 110 receives a process for changing the priority level of the control target application 89A to 3 from the registration terminal 50. The bidirectional communication unit 111 of the management apparatus 110 transmits a notification (setting change notification) indicating that the priority level of the control target application 89A is to be changed to 3 to the control application 90b of the meeting room terminal 90 via the bidirectional communication apparatus 130.

S23: In response to receiving the notification indicating that the priority level of the control target application 89A is to be changed to 3, the bidirectional communication unit 81 of the control application 90b changes the priority level managed by the priority management unit 831. If the control application 90b can have only one priority level for one control target application 89A and the priority level is replaced, the priority level of the control target application 89A changed by the administrator is restored to the previous value, when the control target application 89A notifies the control application 90b of the priority level that the control target application 89A has in advance. For this reason, in the present embodiment, the priority management unit 831 of the control application 90b holds, for each control target application 89, both the priority level that the control target application 89 hold in advance and the priority level of the control target application 89 changed by the administrator. Accordingly, the priority levels managed by the priority management unit 831 are as follows:

Control target application 89A (held in advance): Priority level 1

Control target application 89A (changed by the administrator): Priority level 3

Control target application 89B (held in advance): Priority level 2

Control target application 89B (changed by the administrator): —

S24: The bidirectional communication unit 81 of the control application 90b transmits the updated priority (Control target application 89A: Priority level 3; Control target application 89B: Priority level 2) to the management apparatus 110 via the bidirectional communication apparatus 130. Thus, the management apparatus 110 can provide the current priority to the registration terminal 50.

S25 to S27: As described above with reference to FIG. 11, in a case where there is a new version of the control target application 89, the OS updates the control target application 89.

S28: When the time zone is daytime, the foreground application control unit 832 of the control application 90b identifies the control target application 89 whose priority level is highest and transmits, to the identified control target application 89, a notification indicating that the application screen is to be displayed in the foreground. The priority management unit 831 selects, from among the priority level held by the control target application 89 in advance and the priority level of the control target application 89 changed by the administrator, one priority level that is higher than the other as the priority level of the control target application 89. Alternatively, the priority management unit 831 can select the priority level that is transmitted later in time as the priority level of the control target application 89. Based on the selected priority level of each control target application 89, the priority management unit 831 identifies the control target application 89 whose priority level is highest. Accordingly, for the control target application 89A, the priority level 3 is selected from the priority level 1 (held in advance) and the priority level 3 (changed by the administrator). Further, the control target application 89A is identified as the control target application 89 whose priority level is highest, from among the control target application 89A and the control target application 89B.

S29: The foreground application control unit 832 of the control application 90b transmits, the control target application 89A having the highest priority level, a notification indicating that the application is to be displayed in the foreground.

S30: When the time zone is immediately after when it becomes the daytime, firstly, the control target application 89A is activated and executed. In response to receiving the foreground display notification, the application foreground display unit 952 of the control target application 89A displays the control target application 89A itself in the foreground. Normally, the application displayed in the foreground when activated.

Since the foreground display notification is not transmitted to the control target application 89B, the control target application 89B is kept unstarted. However, since the screen of the control target application 89 is not displayed, there is little actual harm. When the control target application 89B also needs to be activated, the control application 90b periodically transmits an activation notification.

S31: When the control target application 89A starts up, the priority sending unit 951 of the control target application 89A sends the priority level 1, which is held in advance, to the control application 90b. In response to receiving the priority level 1, the priority management unit 831 of the control application 90b manages the received priority level in association with the control target application 89A. The priority management unit 831 manages the priority level 1, which is held by the control target application 89A in advance, separately from the priority level 3, which is the value changed by the administrator. Accordingly, even after the priority sending unit 951 sends the priority level 1, which is held in advance, to the control application 90b, the foreground display notification is sent in the priority level changed by the administrator.

S32: The foreground application control unit 832 of the control application 90b repeatedly sends, to the control target application 89A, which has the highest priority level, the notification indicating that the application is to be displayed in the foreground. Therefore, even in a case where the control target application 89A is not displayed in the foreground at the time of activation due to the timing when another application is activated, for example, the application foreground display unit 952 of the control target application 89A receives the foreground display notification and displays the control target application 89A itself in the foreground.

The description given heretofore with reference to FIG. 14 is of an example in which the administrator changes the priority. In another example, the administrator can change, for example, the setting of daytime and nighttime time zones. Accordingly, the system can support daylight saving time, for example. In addition, the time zone of the daytime and nighttime can be changed according to a day of the week.

Example of Screen:

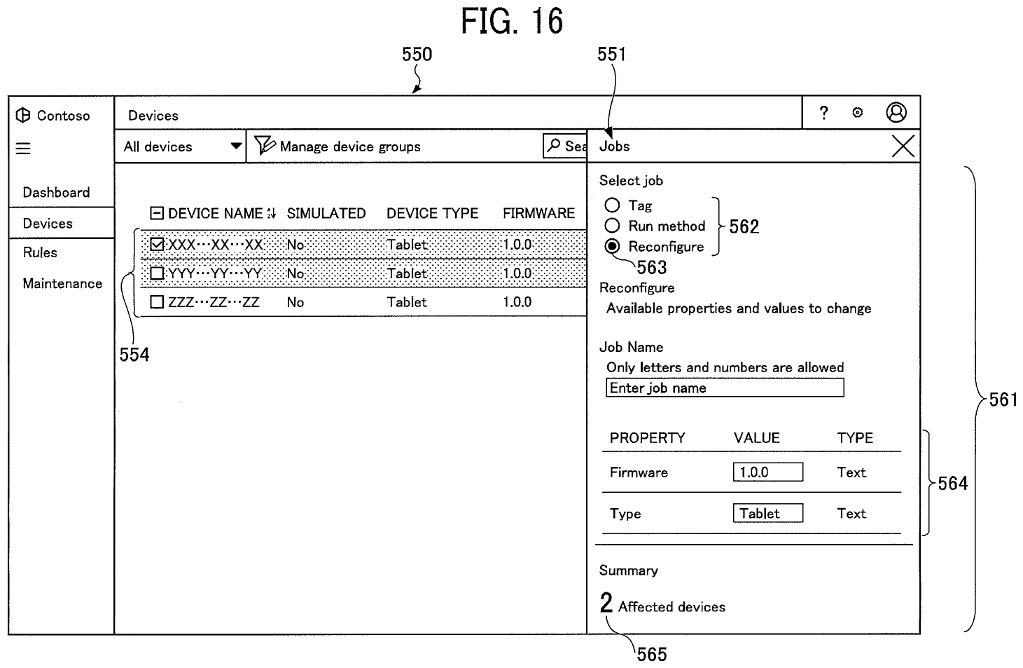

A description is now given of a remote setting screen 550 displayed on the registration terminal 50 in the process of step S21 in FIG. 14, with reference to FIG. 15 and FIG. 16. FIG. 15 illustrates an example of the remote setting screen 550 on which a search result of the meeting room terminal 90 is displayed. On the remote setting screen 550 of FIG. 16, a device name list 554 is displayed, which lists devices obtained by the search.

The remote setting screen 550 includes a Jobs button 551, a Delete button 552, and a New device button 553. The Jobs button 551 is a button for opening a menu for transmitting settings to the meeting room terminal 90. The Delete button 552 is a button for deleting a selected meeting room terminal(s) 90 among the meeting room terminals 90 that are registered. The New device button 553 is a button for newly registering the meeting room terminal 90.

FIG. 16 illustrates an example of the remote setting screen 550 on which a menu 561 for transmitting settings is displayed in response to pressing of the Job button 551. In the menu 561 of FIG. 16, radio buttons 563 are displayed in association with jobs in a job type column 562. In the example of FIG. 16, the radio button for Reconfigure is selected. Reconfigure means a setting change. The menu 561 includes a setting information reception field 564 for receiving setting information. The setting information input in the setting information reception field 564 is transmitted to the meeting room terminal 90. In the present embodiment, the priority level is set in the setting information reception field 564.

The administrator selects the meeting room terminal(s) 90 to which the setting information is to be sent from the device name list 554. As a result, a number 565 indicating the number of meeting room terminals 90 selected in the device name list 554 is displayed in the menu 561. When the administrator presses an Execute button, the operation reception unit 52 receives the press. The communication unit 51 of the registration terminal 50 transmits the setting information configured in the setting information reception field 564 to the meeting room terminal(s) 90 via the management apparatus 110 and the bidirectional communication apparatus 130.

The setting information in the setting information reception field 564 can be acquired (loaded) from the meeting room terminal 90 (loaded), in addition to being input by the administrator. Thus, the administrator can cause plural meeting room terminals 90 to have the same setting information with a simple operation.

As described heretofore, the meeting room terminal 90 according to the present embodiment includes the control target application 89 and the control application 90b that controls the operation of the control target application 89. The control application 90b controls the operation of the control target application 89 according to the time zones or the like. Accordingly, the display of the screen of the control target application 89, the stop and activation of the control target application 89, and the like can be controlled. In a case where there are a plurality of meeting room terminals 90, the workload of the administrator can be reduced.

Variation:

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

For example, in the present embodiment, control as to which application is to be displayed in the foreground is performed based on the priority level. In another example, the application is identified by application identification information and the control is performed based on the application identification information. This method is effective when the control application 90b knows what control target applications 89 can be installed. Further, the control application 90b is saved from inquiring the priority level.

In still another example, the control target application 89 holds the identification information and the priority levels of the application in advance. In this case, the identification information of the control target application 89 determined based on the priority level is specified, to control the foreground display, stop, activation, or the like.

In still another example, the control application 90b changes the control target application 89 to be displayed in the foreground according to the time zones. For example, the control target application 89A is brought to the foreground in the morning, and the control target application 89B is brought to the foreground in the afternoon.

In still another example, the control application 90b change the control target application to be displayed in the foreground according to whether a meeting is being conducted. The terminal application 90a accepts check-in and sends a notification indicating that a meeting is being conducted to the control application 90b. During the meeting, the control application 90b displays the application whose priority level is lowest so that the operation screen of the electronic whiteboard is displayed in the foreground instead of the standby screen.

In still another example, the control application 90b can configure settings in the control target application 89 or the OS as to whether or not the control target application 89 is to be automatically activated after the automatic update.

Although in the present embodiment, the description heretofore of an example case in which the OS is Android. However, Android is just an example, and any other suitable OS can be used such as iOS (registered trademark) or Windows (registered trademark).

Further, in the present embodiment, the description heretofore is of an example case in which the meeting management server 30, the management apparatus 110, and the bidirectional communication apparatus 130 resides in the cloud network. Alternatively, the meeting management server 30, the management apparatus 110, and the bidirectional communication apparatus 130 can reside in the on-premises network.

In addition, the resource reservation system 100 can include a plurality of meeting management servers 30. The meeting management server 30 can be configured as a plurality of servers to which divided functions are arbitrary allocated. The reservation management server 20 and the meeting management server 30 can be implemented by a single entity.

The resource reservation system 100 of the present embodiment can also be referred to as a “web service”. The web service refers to various services provided by the Internet-related technologies. Examples of the web service include various rental services such as a meeting room rental service. A system that uses the service is called a usage system.

In addition, the functional configuration of the resource reservation system 100 are divided into the functional blocks as illustrated in FIGS. 6A and 6B and FIGS. 7A and 7B, for example, based on main functions thereof, in order to facilitate understanding the processes performed by the resource reservation system 100. No limitation is intended by how the processes are divided or by the name of the processes. The resource reservation system 100 can also be divided into more processing units according to the processing contents. Further, one process can be divided to include a larger number of processes.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

The in-terminal communication unit 83 is an example of notification transmitting means. The in-terminal communication unit 95 is an example of notification receiving means. The application foreground display unit 952 and the application stop unit 953 are an example of application control means. The automatic update unit 86 is an example of update means. The priority management unit 831 is an example of priority management means. The bidirectional communication unit 81 is an example of communication means.

According to the conventional art, an operation of the application cannot be controlled. For example, a system according to the conventional art cannot control which application is to be displayed preferentially nor control the startup and stop of an application. For this reason, conventionally, an administrator has to visit a place where an information processing terminal is located to configure settings of the information processing terminal. In a case where there are plural information processing terminals, the administrator has to configure the same settings for each of the plural information processing terminals.

According to one or more embodiments of the present disclosure, an information processing terminal that controls operation of an application is provided.

What is claimed is:

1. An information processing terminal, installed with one or more control target applications, comprising:
one or more control target applications;
one or more processors configured to:
transmit a notification for controlling the one or more control target applications; and
execute the one or more control target applications to receive the notification and control operation of the one or more control target applications based on the received notification.

2. The information processing terminal of claim 1,
wherein the one or more processors are further configured to:
acquire from an application server through a network a new version of the one or more control target applications and update the one or more control target applications with the new version of the one or more control target applications; and
transmit a notification for controlling the updated one or more control target applications, and
wherein the updated one or more control target applications configure the one or more processors to receive the notification, and control operation of the one or more updated control target applications based on the received notification.

3. The information processing terminal of claim 1,
wherein a control application installed in the information processing terminal configures the one or more processors to transmit the notification, and
wherein the control application is resident application software, which operates in a background.

4. The information processing terminal of claim 3,
wherein the control application is a home application, which displays a home screen.

5. The information processing terminal of claim 2,
wherein the control application configures the one or more processors to
transmit a notification for stopping execution of the one or more control target applications to the one or more control target applications, and update the one or more control target applications that are stopped.

6. The information processing terminal of claim 1,
wherein the one or more processors are further configured to:
store, in a memory, priority levels of a plurality of control target applications including the one or more control target applications; and
transmit, to a particular control target application whose priority level is highest from among the plurality of control target applications, a notification indicating that a screen of the particular control target application is to be displayed in a foreground, and
wherein the particular control target application configures the one or more processors to display the screen of the particular control target application more in the foreground than the rest of the plurality of control target applications.

7. The information processing terminal of claim 6,
wherein the one or more processors are further, configured to:
transmit, to the particular control target application whose priority level is highest, the notification indicating that the screen of the particular control target application is to be displayed in the foreground, repeatedly in a first time zone, which is determined in advance; and
transmit, a notification for stopping execution of the one or more control target applications to the one or more control target applications repeatedly in a second time zone, which is determined in advance.

8. The information processing terminal of claim 6,
wherein the one or more processors are further configured to:
transmit, to each of one or more control target applications, an inquiry inquiring a priority level that each of the plurality of control target applications stores in advance, to acquire the priority level from each of the one or more control target applications; and
transmit, to the particular control target application whose priority level is highest, the notification indicating that the screen of the particular control target application is to be displayed in the foreground.

9. The information processing terminal of claim 6,
wherein the one or more processors are further configured to:
communicate with a control apparatus via a network;
store, in a memory, a priority level transmitted from the control apparatus, the priority level being associated with the one or more control target applications; and
transmit, to the particular control target application whose priority level is highest, the notification indicating that the screen of the particular control target application is to be displayed in the foreground.

10. The information processing terminal of claim 9,
wherein the one or more processors are further configured to:
identify a higher one of the priority level of each of the one or more control target applications transmitted from the control apparatus and the priority level acquired from each of the one or more control target applications as the priority level of each of the one or more control target applications; and
transmit, to the particular control target application whose priority level is highest, the notification indicating that the screen of the particular control target application is to be displayed in the foreground.

11. The information processing terminal of claim 1, wherein
the one or more control target applications include an application that, when executed, acquires reservation information from an information processing apparatus storing reservation information of a resource and displays the acquired reservation information, and
the one or more processors execute the application to display the reservation information in a foreground based on the received notification.

12. A resource reservation system comprising:
an information processing apparatus that stores reservation information of a resource; and
an information processing terminal that acquires the reservation information from the information processing apparatus;
the information processing apparatus including a first processor to transmit the reservation information in response to a request from the information processing terminal;
the information processing terminal including:
a control target application that, when executed, acquires the reservation information from the information processing apparatus and displays the reservation information, the control target application being installed in the information processing terminal; and
a second processor configured to:
transmit a notification for controlling the control target application; and
execute the control target application to receive the notification and control operation of the control target application based on the received notification.

13. A method of controlling an application, performed by an information processing terminal installed with one or more control target applications, the method comprising:
transmitting a notification for controlling the one or more control target applications; and
executing the one or more control target applications to receive the notification and control operation of the one or more control target application based on the received notification.
